(19) United States
(12) Patent Application Publication
(10) Pub. No.: US 2026/0332619 A1
(43) Pub. Date: Oct. 22, 2026

(54) MULTI-VECTOR CORRELATION USING THREAT AND ANOMALY ANALYSES TO ASSESS A REAL-TIME SECURITY THREAT

(71) Applicant: Microsoft Technology Licensing, LLC, Redmond, WA (US)

(72) Inventor: Prachi GUPTA, Peoria, AZ (US)

(21) Appl. No.: 19/185,124

(22) Filed: Apr. 21, 2025

(51) Int. Cl. H04L 9/40; H04L 41/16

(52) U.S. Cl. CPC H04L 63/1425; H04L 41/16

(57) ABSTRACT

Techniques are described herein that are capable of performing a multi-vector correlation using threat and anomaly analyses to assess a real-time security threat. A supervised AI model is caused to determine a first extent to which relationships between more than two vectors in a multi-vector representation, which indicate telemetry associated with a machine, correspond to first reference relationships associated with a known security threat. An unsupervised AI model is caused to determine a second extent to which the relationships differ from second reference relationships associated with a machine type of the machine. A security score is generated by combining indications of the first and second extents. A security action is performed as a result of the security score satisfying a security threat criterion.

### BACKGROUND

Conventional security analysis techniques often are unable to correlate various types of activities associated with a system in real-time or at all. The conventional security analysis techniques therefore typically analyze different types of activities in isolation, which increases a likelihood of a false positive or a false negative. For instance, analyzing the different types of activities in isolation may frustrate attempts to identify or evaluate dynamically changing security threats. A false positive is an incorrect determination that a benign occurrence is a security threat. A security threat is an occurrence that threatens security of a system and/or a user of the system. A benign occurrence is an occurrence that does not constitute a security threat. Accordingly, the benign occurrence is an occurrence that does not threaten security of a system and/or a user of the system. An occurrence includes one or more activities. A false negative is an incorrect determination that a security threat is a benign occurrence. Even if the conventional security analysis techniques are capable of identifying or evaluating dynamically changing security threats, the response times for doing so often are relatively long.

### SUMMARY

It may be desirable to use artificial intelligence (AI) model to assess a real-time security threat using multi-vector correlation to increase security of a system (e.g., a machine) and/or a user of the system. In an aspect, the security analysis correlates multiple vectors indicating telemetry associated with the system using threat analysis and anomaly analysis. In another aspect, the security of the system and/or the user of the system is increased by reducing a likelihood (e.g., statistical probability) of a false positive or a false negative.

A security analysis is an analysis that is configured to identify and/or evaluate a threat, vulnerability, and/or risk to security of a system and/or a user of the system. A threat analysis is an analysis that compares information regarding a system and reference information associated with a known security threat to determine whether a security threat exists (e.g., occurs). An anomaly analysis is an analysis that compares information regarding a system and reference information associated with a particular type of system to determine whether an anomaly exists with regard to the particular type of system.

Telemetry associated with a system is data that indicates attribute(s) of the system. An attribute may indicate performance of the system, a security event associated with the system, an operational status of the system, and so on Examples of telemetry include but are not limited to connection data, process data, and machine data. Connection data is data that indicates attribute(s) of network connection(s). A network connection is a connection between a first system and a second system via a network. Process data is data that indicates operation(s) performed by process(es) that execute on a machine. Machine data is data that indicates a type of a machine. Examples of a type of a machine include but are not limited to a web server, a database server, and an application server.

Various approaches are described herein for, among other things, performing a multi-vector correlation using threat and anomaly analyses to assess a real-time security threat. In a first example approach, a multi-vector representation that indicates telemetry associated with a machine is generated. The multi-vector representation comprises more than two vectors. A threat score is generated by analyzing relationships between the more than two vectors and first reference relationships associated with a known security threat using a supervised AI model. The threat score indicates a first extent to which the relationships correspond to the first reference relationships. An anomaly score is generated by analyzing the relationships between the more than two vectors and second reference relationships associated with a machine type of the machine using an unsupervised AI model. The anomaly score indicates a second extent to which the relationships differ from the second reference relationships. A security score is generated by combining the threat score and the anomaly score. A security action is performed as a result of the security score satisfying a security threat criterion.

In a second example approach, a supervised AI model is caused to determine a first extent to which relationships between more than two dynamically changing vectors in a multi-vector representation correspond to first reference relationships associated with a known security threat. The more than two dynamically changing vectors represent respective subsets of telemetry associated with a machine over a sliding window of time. The supervised AI model is caused to determine the first extent by causing the supervised AI model to analyze the relationships and the first reference relationships. An unsupervised AI model is caused to determine a second extent to which the relationships between the more than two dynamically changing vectors differ from second reference relationships associated with a machine type of the machine. The unsupervised AI model is caused to determine the second extent by causing the unsupervised AI model to analyze the relationships and the second reference relationships. A security score is generated by combining a threat score and an anomaly score. The threat score indicates the first extent to which the relationships correspond to the first reference relationships associated with the known security threat. The anomaly score indicates the second extent to which the relationships differ from the second reference relationships associated with the machine type of the machine. A security action is performed as a result of the security score satisfying a security threat criterion.

In a third example approach, a first vector that represents first attributes of a network connection between the machine and an entity is generated. A second vector that represents second attributes of an operation performed by a process that executes on the machine is generated. A third vector that represents third attributes of a machine type of the machine is generated. A threat score is generated by analyzing relationships between the first vector, the second vector, and the third vector and first reference relationships associated with a known security threat using a supervised AI model. The threat score indicates a first extent to which the relationships correspond to the first reference relationships. An anomaly score is generated by analyzing the relationships between the first vector, the second vector, and the third vector and second reference relationships associated with the machine type of the machine using an unsupervised AI model. The anomaly score indicates a second extent to which the relationships differ from the second reference relationships. A security score is generated by combining the threat score and the anomaly score. A security action is performed as a result of the security score satisfying a security threat criterion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example hybrid AI analysis-based security action logic in accordance with an embodiment.

FIGS. 2-5 depict flowcharts of example methods for performing a security action based on threat and anomaly analyses using connection, process, and machine data in accordance with embodiments.

FIG. 6 is a block diagram of an example computing system in accordance with an embodiment.

FIG. 7 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to use artificial intelligence (AI) model to assess a real-time security threat using multi-vector correlation to increase security of a system (e.g., a machine) and/or a user of the system. In an aspect, the security analysis correlates multiple vectors indicating telemetry associated with the system using threat analysis and anomaly analysis. In another aspect, the security of the system and/or the user of the system is increased by reducing a likelihood (e.g., statistical probability) of a false positive or a false negative.

A security analysis is an analysis that is configured to identify and/or evaluate a threat, vulnerability, and/or risk to security of a system and/or a user of the system. An example of a system includes but is not limited to a computing system (e.g., a component of the computing system or data stored on, generated by, or used by the computing system). In an aspect, the computing system is a machine (e.g., a physical machine or a virtual machine). Examples of a component of a computing system include but are not limited to a physical hardware component (e.g., a physical memory or a physical processor system), a virtual hardware component (e.g., a virtual memory or a virtual processor system), and a software component (e.g., a software program that runs on the computing system). Examples of a software program include but are not limited to an application and an AI model. In an example, the data includes (e.g., is) a secret. Examples of a secret include but are not limited to a certificate, a configuration setting, a token, a cryptographic key, and a credential. Examples of a cryptographic key include but are not limited to an application programming interface (API) key, a secure shell (SSH) key, an encryption key, and a decryption key. A cryptographic key may be an asymmetric key (e.g., a private key or a public key) or a symmetric key. Examples of a credential include but are not limited to a username, a password, and a personal identification number (PIN).

A threat analysis is an analysis that compares information regarding a system and reference information associated with a known security threat to determine whether a security threat exists (e.g., occurs). In an aspect, the information regarding the system corresponding to the reference information to a greater extent weighs in favor of (e.g., corresponds to) a higher likelihood of a security threat. In an example of this aspect, the information corresponding to the reference information to an extent that is greater than or equal to an extent threshold (e.g., 50%, 75%, or 90%) indicates existence of the security threat. In accordance with this aspect, the information regarding the system corresponding to the reference information to a lesser extent weighs in favor of (e.g., corresponds to) a lower likelihood of a security threat. In an example of this aspect, the information corresponding to the reference information to an extent that is less than or equal to an extent threshold (e.g., 50%, 25%, or 10%) indicates that of the security threat does not exist.

An anomaly analysis is an analysis that compares information regarding a system and reference information associated with a particular type of system to determine whether an anomaly exists with regard to the particular type of system. In an aspect, the information regarding the system differing from the reference information to a greater extent weighs in favor of (e.g., corresponds to) a higher likelihood of an anomaly. In an example of this aspect, the information differing from the reference information to an extent that is greater than or equal to an extent threshold (e.g., 25%, 40%, or 60%) indicates existence of the anomaly. In accordance with this aspect, the information regarding the system differing from the reference information to a lesser extent weighs in favor of (e.g., corresponds to) a lower likelihood of an anomaly. In an example of this aspect, the information differing from the reference information to an extent that is less than or equal to an extent threshold (e.g., 25%, 40%, or 60%) indicates that of the anomaly does not exist.

Telemetry associated with a system is data that indicates attribute(s) of the system. An attribute may indicate performance of the system, a security event associated with the system, an operational status of the system, and so on Examples of telemetry include but are not limited to connection data, process data, and machine data.

Connection data is data that indicates attribute(s) of network connection(s). A network connection is a connection between a first system and a second system via a network. Examples of an attribute of a network connection include but are not limited to a source Internet Protocol (IP) address, a destination IP address, a reputation associated with a source IP address or a destination IP address, a port number, a protocol used for communication via the network connection, a duration of the network connection, a volume of data transmitted via the network connection, a proportion of bandwidth of the network connection that is utilized (e.g., an instantaneous data transfer rate or a moving average of a data transfer rate of the network connection), entropy of a payload of the network connection, a time instance at which the network connection is established, a time instance at which the network connection is terminated, content of information (e.g., packets) that are transmitted via the network connection, a domain name system (DNS) request that is transmitted via the network connection, a geographical location corresponding to an IP address associated with the network connection, and an autonomous system number (ASN) corresponding to an IP address associated with the network connection. An example of an attribute that is applicable to multiple network connections includes but is not limited to a frequency with which connections (e.g., inbound connections and/or outbound connections) are made with regard to a machine. Examples of a protocol include but are not limited to hypertext transfer protocol (HTTP), developed collaboratively by the European Organization for Nuclear Research (CERN), the Internet Engineering Task Force (IETF), and the World Wide Web Consortium (W3C); hypertext transfer protocol secure (HTTPS), file transfer protocol (FTP), developed by Abhay Bhushan; Internet protocol (IP), developed by Vint Cerf and Bob Kahn; transmission control protocol (TCP), developed by Vint Cerf and Bob Kahn; and user datagram protocol (UDP), developed by David P. Reed. In an aspect, the connection data indicates a number of network connection events associated with the machine, a number of network connections established, and/or a number of established network connections that are terminated (e.g., disconnected). In another aspect, each of the first system and the second system is a user device, an autonomous device, a web server, a database, an application server, a cloud service, an Internet-of-Things (IoT) device, a network printer, or a remote desktop.

The connection data may be collected in an any of a variety of ways. In an example, the connection data is collected using NF tables, IP tables, an extended Berkeley packet filter (eBPF) technique, or an auditing technique.

Process data is data that indicates operation(s) performed by process(es) that execute on a machine. Example types of operations that may be performed by a process include but are not limited to file operations, memory operations, process management operations, networking operations, user operations, and device operations. Examples of a file operation include but are not limited to opening a file, closing a file, reading a file, writing to a file, deleting a file, and renaming a file. Examples of a memory operation include but are not limited to allocating memory (i.e., reserving a block of memory for use), deallocating memory (i.e., releasing previously allocated memory), reading data that is stored in memory, and writing (e.g., storing) data in memory. Examples of a process management operation include but are not limited to creating a process, terminating a running process, suspending (e.g., pausing) a process temporarily, and resuming a suspended process. Examples of a networking operation include but are not limited to opening a socket (i.e., establishing a network connection), closing a socket (i.e., terminating a network connection), transmitting data over a network, and receiving data via a network. Examples of a user operation include but are not limited to authenticating a user, starting a user session, ending a user session, creating a permission for a user, terminating an existing permission of a user, and changing a permission of a user (e.g., increasing or decreasing the permission). Examples of a device operation include but are not limited to reading data from a hardware device, writing (e.g., sending) data to a hardware device, and sending control commands to a hardware device (e.g., adjusting a clock of the hardware device). In an aspect, the process data indicates parent-child relationships between processes, a lineage of a process, an identifier (e.g., a numerical identifier or a name) of a process, a system call pattern associated with a process (e.g., a frequency with which the process initiates calls), an extent to which a processor system (e.g., a central processing unit (CPU)) is used by a process, an extent to which a memory is used by a process, and/or a number of input/output (I/O) operations performed by a process.

The process data may be collected in an any of a variety of ways. In an example, the process data is collected using a BPF-based technique, an auditing technique, Linux® Trace Toolkit: Next Generation (LTTNG™), system call tracing, a performance monitoring tool, an event logging framework, an open-source intelligence (OSINT), or a network traffic monitoring tool.

Machine data is data that indicates a type of a machine. Examples of a type of a machine include but are not limited to a web server, a database server, and an application server. A web server is a server that processes HTTP requests from client(s) (e.g., a web browser). In an aspect, the web server provides static content in response to receipt of an HTTP request. Examples of static content include but are not limited to an HTML page, an image, a cascading style sheets (CSS™) file, and a JavaScript® file. A database server is a server that provides database services to other systems (e.g., computers or applications). In an aspect, the database server stores, retrieves, and manages data in a structured format. An application server is a server that hosts and runs an application. In an aspect, the application server provides a runtime environment for the application. In another aspect, the application server implements business logic, handles database interactions, and/or manages user sessions. Examples of an application server include but are not limited to an email server, a file server, a game server, a media server, and an application framework server. In an aspect, the machine data indicates a historical pattern (e.g., historical behavioral pattern) of the machine (e.g., historical operations performed by the machine). In an example of this aspect, the historical pattern indicates the type of the machine (e.g., as a result of the historical behavior pattern corresponding to a reference pattern (e.g., a reference behavioral pattern) associated with the type). In another aspect, the machine data indicates an identifier (e.g., a numerical identifier or a name) of the machine, a type of operating system that is installed on the machine, one or more applications that are installed on the machine, and/or a subscription associated with the machine.

The machine data may be collected in an any of a variety of ways. In an example, the machine data is collected from a register associated with the machine or a database that stores information about the machine. In another example, the machine data is derived from historical behavior of the machine. For instance, information regarding the historical behavior of the machine may be stored in a database.

An AI model is a model that utilizes artificial intelligence to perform a task in response to an AI input that is received by the AI model. Artificial intelligence is intelligence of a machine (e.g., a computing system) and/or code (e.g., software and/or firmware), as opposed to intelligence of a living creature (e.g., a human). In an aspect, the AI model is an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal. In another aspect, the AI model is a machine learning model. A machine learning model is an AI model that is configured to learn (e.g., acquire intelligence) from data and to make determinations (e.g., predictions) based on the data (e.g., based on the acquired intelligence). In an example implementation, the machine learning model is capable of modifying itself (e.g., its algorithm) to make determinations that are more accurate, precise, and/or relevant to an AI input without being explicitly programmed to do so.

An AI input indicates (e.g., specifies) a task that is to be performed by an AI model. Examples of an AI input include but are not limited to an AI prompt and an application programming interface (API) input. An AI prompt is an AI input that causes (e.g., triggers) an AI model to generate an answer that is responsive to the AI prompt. An answer to an AI prompt is referred to herein as an “AI response.” Examples of an AI prompt include but are not limited to a zero-shot prompt, a one-shot prompt, and a few-shot prompt. A zero-shot prompt is a prompt that indicates a task to be performed by an AI model that has not been trained on example(s) of the task. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

In an example, an AI prompt is a natural language prompt. A natural language prompt is a prompt that is written in a natural language. A natural language is a human language that has developed through use and repetition. In an example, the natural language has developed naturally without conscious planning or premeditation. Examples of a natural language include English, French, Spanish, and Mandarin. In an aspect, the natural language prompt is generated by a user (e.g., a human). In another aspect, the natural language prompt is generated by a computing system (e.g., an AI assistant that runs on the computing system).

In another example, an AI prompt is not written in a natural language. In an implementation of this example, the AI prompt includes (e.g., is) computer code. The AI prompt may be any suitable sequence of characters that is capable of being interpreted by an AI model.

An API input is an AI input that is provided via an API to request a service or a function. An API is an interface between a computing system and code (e.g., software or firmware).

A supervised AI model is an AI model that is trained using labeled data. Labeled data is data that includes one or more input-output pairs. An input-output pair includes an input and a corresponding output. In an aspect, the input is an AI input, and the corresponding output is an AI response that corresponds to the AI input. In another aspect, training the supervised AI model using the labeled data enables the supervised AI model to generate an AI response in response to a previously unknown AI input. Examples of a supervised AI model include but are not limited to an extreme gradient boosting (i.e., XGBoost) model, a linear regression model, a logistic regression model, a support vector machine (SVM), a decision tree, and a neural network.

An unsupervised AI model is an AI model that is trained using unlabeled data. Unlabeled data is data that does not include an input-output pair. In an aspect, training the unsupervised AI model using the unlabeled data enables the unsupervised AI model to identify a pattern or a structure within data (e.g., without predefined labels). In an example of this aspect, the unsupervised AI model is trained to identify hidden patterns or groupings of information within the data. Examples of an unsupervised AI model include but are not limited to an isolation forest model, a K-means clustering model, a principal component analysis (PCA) model, a hierarchical clustering model, an autoencoder, and a Gaussian mixture model (GMM).

Example embodiments described herein are capable of performing a multi-vector correlation using threat and anomaly analyses to assess a real-time security threat. In an aspect, the example embodiments correlate multiple vectors indicating telemetry associated with a system (e.g., a machine) using the threat and anomaly analyses. Example techniques described herein have a variety of benefits as compared to conventional security analysis techniques. For instance, the example techniques are capable of increasing security of a system associated with the vectors. In an aspect, the example techniques reduce a likelihood of a false positive or a false negative. In another aspect, the example techniques increase an accuracy (e.g., statistical accuracy), precision (e.g., statistical precision), reliability, speed, and/or efficiency with which a security threat is identified, evaluated (e.g., investigated or triaged), and/or addressed (e.g., mitigated, contained, resolved, eliminated, or remediated). The example techniques are capable of identifying and/or evaluating real-time (e.g., dynamically changing) security threats. The example techniques are more scalable than conventional security analysis techniques. For instance, the example techniques are capable of scaling to millions of machines using distributed architectures, parallelization techniques, and optimization algorithms that reduce computational overhead while maintaining accuracy of security threat detections. In an example, the computational overhead associated with the example techniques is less than one percent (e.g., <1% CPU utilization). In another example, the example techniques consume less than 100 megabytes (MB) of memory. The example techniques are capable of autonomously initiating real-time security actions to mitigate detected security threats, which may minimize an impact of corresponding security breaches. The example techniques are capable of being tailored to a particular operating system environment (e.g., a Linux®-based environment or a Windows®-based environment).

The example techniques are capable of reducing an amount of time and/or resources (e.g., processor cycles, memory, network bandwidth) that is consumed by a computing system to identify, evaluate, and/or address a security threat (e.g., a real-time security threat). In a first aspect, by generating a multi-vector representation that indicates telemetry associated with a machine, the multi-vector representation comprising more than two vectors; generating a threat score by analyzing relationships between the more than two vectors and first reference relationships associated with a known security threat using a supervised AI model; generating an anomaly score by analyzing the relationships between the more than two vectors and second reference relationships associated with a machine type of the machine using an unsupervised AI model; generating a security score by combining the threat score and the anomaly score; and/or performing a security action as a result of the security score satisfying a security threat criterion, the example techniques reduce the amount of time and/or resources that is consumed to identify, evaluate, and/or address a security threat.

In a second aspect, by causing a supervised AI model to determine a first extent to which relationships between more than two dynamically changing vectors in a multi-vector representation, which represent respective subsets of telemetry associated with a machine over a sliding window of time, correspond to first reference relationships associated with a known security threat; causing an unsupervised AI model to determine a second extent to which the relationships between the more than two dynamically changing vectors differ from second reference relationships associated with a machine type of the machine; generating a security score by combining a threat score, which indicates the first extent to which the relationships correspond to the first reference relationships associated with the known security threat, and an anomaly score, which indicates the second extent to which the relationships differ from the second reference relationships associated with the machine type of the machine; and/or performing a security action as a result of the security score satisfying a security threat criterion, the example techniques reduce the amount of time and/or resources that is consumed to identify, evaluate, and/or address a security threat.

In a third aspect, by generating a first vector that represents first attributes of a network connection between the machine and an entity; generating a second vector that represents second attributes of an operation performed by a process that executes on the machine; generating a third vector that represents third attributes of a machine type of the machine; generating a threat score by analyzing relationships between the first vector, the second vector, and the third vector and first reference relationships associated with a known security threat using a supervised artificial intelligence (AI) model, the threat score indicating a first extent to which the relationships correspond to the first reference relationships; generating an anomaly score by analyzing the relationships between the first vector, the second vector, and the third vector and second reference relationships associated with the machine type of the machine using an unsupervised AI model, the anomaly score indicating a second extent to which the relationships differ from the second reference relationships; generating a security score by combining the threat score and the anomaly score; and/or performing a security action as a result of the security score satisfying a security threat criterion, the example techniques reduce the amount of time and/or resources that is consumed to identify, evaluate, and/or address a security threat.

In an example implementation, the example techniques automate identifying, evaluating, and/or addressing a security threat. For instance, the example techniques may automate any one or more of the operations described above with regard to the first, second, and/or third aspects. In another example implementation, by reducing the amount of time and/or resources that is consumed by a computing system to identify, evaluate, and/or address a security threat, the efficiency of the computing system is increased. In yet another example implementation, by reducing the amount of time and/or resources that is consumed by a computing system to identify, evaluate, and/or address a security threat, a cost associated with identifying, evaluating, and/or addressing the security threat is reduced.

In an aspect, by reducing the amount of time that is consumed to identify, evaluate, and/or address a security threat, the example techniques increase a user experience and/or efficiency of an IT professional who manages security of a system associated with (e.g., targeted by) the security threat. The example techniques may reduce a number of tasks that are manually performed by the IT professional by utilizing artificial intelligence and/or by automating identification, evaluation, and/or addressing of the security threat. In another aspect, the example techniques increase a user experience and/or efficiency of an end user who accesses (e.g., utilizes) the system, for example, by reducing a likelihood that a security threat will negatively impact the end user.

By performing a multi-vector correlation using threat and anomaly analyses to assess a real-time security threat (e.g., and using AI models to perform the threat and anomaly analyses), the example techniques are capable of reducing an amount of time and/or resources that is consumed by an IT professional to identify, evaluate, and/or address a security threat. By reducing the amount of time that is consumed by the IT professional to identify, evaluate, and/or address the security threat, the example techniques are capable of increasing security of a system associated with the security threat. In an aspect, by reducing the amount of time that is consumed, potential security threats are identified, evaluated, and/or addressed more quickly.

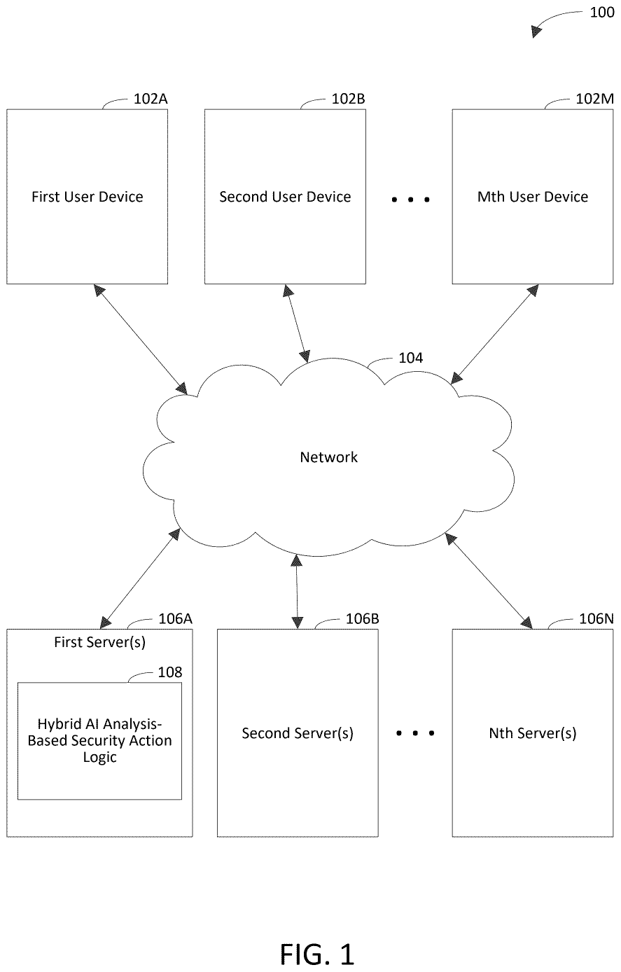

FIG. 1 is a block diagram of an example hybrid AI analysis-based security action system 100 in accordance with an embodiment. Generally speaking, the hybrid AI analysis-based security action system 100 operates to provide information to users in response to requests (e.g., hypertext transfer protocol (HTTP) requests) that are received from the users. In an aspect, the information includes documents (Web pages, images, audio files, video files, etc.), output of executables, and/or any other suitable type of information. In accordance with example embodiments described herein, the hybrid AI analysis-based security action system 100 performs a multi-vector correlation using threat and anomaly analyses to assess a real-time security threat. Detail regarding techniques for performing a multi-vector correlation using threat and anomaly analyses to assess a real-time security threat is provided in the following discussion.

As shown in FIG. 1, the hybrid AI analysis-based security action system 100 includes a plurality of user devices 102A-102M, a network 104, and a plurality of servers 106A-106N. Communication among the user devices 102A-102M and the servers 106A-106N is carried out over the network 104 using well-known network communication protocols. In an aspect, the network 104 is a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors. In an example, the one or more processors are on a same (e.g., single) device. In another example, the one or more processors are distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. In an example, a user initiates a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M are able to access information that is available via the domains. In an aspect, the domain include Web page(s). In an example, the Web page(s) are provided as hypertext markup language (HTML) documents and objects (e.g., files) that are linked therein.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. In an example, the information includes documents (Web pages, images, audio files, video files, etc.), output of executables, or any other suitable type of information. In accordance with some example embodiments, the servers 106A-106N are configured to host respective Web sites, so that the Web sites are accessible to users of the hybrid AI analysis-based security action system 100.

One example type of computer program that may be executed by one or more of the servers 106A-106N is a computer security program. A computer security program is a computer program that provides security with regard to information and/or communications associated with a computing system. In an example, the information associated with the computing system includes information stored on the computing system and/or information accessed (e.g., read) by the computing system. In another example, the communications associated with the computing system includes communications received by the computing system and/or communications provided (e.g., transmitted) by the computing system. An example of a communication is an electronic message. Examples of a computer security program include Bitdefender® security program, developed and distributed by Bitdefender IPR Management Ltd.; Norton® security program, developed and distributed by Gen Digital Inc.; Avast® security program, developed and distributed by Avast Software S.R.O.; McAfee® security program, developed and distributed by McAfee, LLC; and Microsoft Defender® security program, developed and distributed by Microsoft Corporation. In an example implementation, one or more of the example techniques described herein are implemented using a computer security program. In an example, a software product (e.g., a subscription service, a non-subscription service, or a combination thereof) includes the computer security program, and the software product is configured to perform the example techniques.

In an aspect, the computer security program is a cloud native application protection platform (CNAPP). A CNAPP is an all-in-one platform that unifies security and compliance capabilities to prevent, detect, and respond to cloud security threats. A CNAPP integrates multiple cloud security solutions, which traditionally have been siloed, into a common (e.g., single) user interface. In an example, the cloud security solutions include cloud security posture management (CSPM), multipipeline development and operations (DevOps) security, a cloud workload protection platform (CWPP), cloud infrastructure entitlement management (CIEM), and/or cloud service network security (CSNS). CSPM provides a connected, prioritized view of potential vulnerabilities and misconfigurations across multi-cloud and hybrid environments. The CSPM continuously assesses overall security posture of a system and provides automated alerts and recommendations about critical issues that could expose the system to data breaches. In an example, the CSPM includes automated compliance management and remediation tools to identify and remedy compliance deficiencies. Multipipeline DevOps security provides a central console that enables management of DevOps security across multiple (e.g., all) pipelines. In an example, the multipipeline DevOps security is used to reduce cloud misconfigurations and to scan new code to keep vulnerabilities therein from reaching a production environment. In another example, the multipipeline DevOps security includes infrastructure-as-code scanning tools that analyze configuration files from the earliest stages of development to confirm that new configuration files are compliant with security policies. A CWPP provides real-time detection and response to threats based on up-to-date information regarding multi-cloud workloads (e.g., virtual machines, containers, Kubernetes, databases, storage accounts, network layers, and app services). In an example, the CWPP enables a quick investigation into threats and reduce the attack surface of a system. CIEM centralizes permissions management across a cloud and hybrid footprint, which inhibits (e.g., prevents) accidental or malicious misuse of permissions. CSNS complements the CWPP by protecting cloud infrastructure in real time. In an example, the CSNS includes one or more security tools. Examples of a security tool include but are not limited to distributed denial-of-service protection, a web application firewall, transport layer security examination, and load balancing.

In an aspect, a computer security program is incorporated into a cloud computing program (e.g., a cloud service). A cloud computing program is a computer program that provides hosted service(s) via a network (e.g., network 104). In an example, the hosted service(s) are hosted by any one or more of the servers 106A-106N. In another example, the cloud computing program enables users (e.g., at any of the user systems 102A-102M) to access shared resources that are stored on or are otherwise accessible to the server(s) via the network.

In an example of this aspect, the cloud computing program provides hosted service(s) according to a service model. Examples of a service model include but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). In an example, IaaS provides to the user virtualized computing resources that utilize the IaaS provider's physical computer resources.

Examples of a cloud computing program include but are not limited to a Google Cloud® program developed and distributed by Google Inc.; an Oracle Cloud® program developed and distributed by Oracle Corporation; an Amazon Web Services® program developed and distributed by Amazon. com, Inc.; a Salesforce® program developed and distributed by Salesforce. com, Inc.; an AppSource® program developed and distributed by Microsoft Corporation; an Azure® program developed and distributed by Microsoft Corporation; a GoDaddy® program developed and distributed by GoDaddy. com LLC; and a Rackspace® program developed and distributed by Rackspace US, Inc. In an aspect, one or more of the example techniques described herein are implemented using a cloud computing program. In an example, a software product (e.g., a subscription service, a non-subscription service, or a combination thereof) includes the cloud computing program, and the software product is configured to perform the example techniques.

The first server(s) 106A are shown to include hybrid AI analysis-based security action logic 108 for illustrative purposes. The hybrid AI analysis-based security action logic 108 is configured to perform a multi-vector correlation using threat and anomaly analyses to assess a real-time security threat. In a first example implementation, the hybrid AI analysis-based security action logic 108 generates a multi-vector representation that indicates telemetry associated with a machine. The multi-vector representation comprises more than two vectors. The hybrid AI analysis-based security action logic 108 generates a threat score by analyzing relationships between the more than two vectors and first reference relationships associated with a known security threat using a supervised AI model. The threat score indicates a first extent to which the relationships correspond to the first reference relationships. The hybrid AI analysis-based security action logic 108 generates an anomaly score by analyzing the relationships between the more than two vectors and second reference relationships associated with a machine type of the machine using an unsupervised AI model. The anomaly score indicates a second extent to which the relationships differ from the second reference relationships. The hybrid AI analysis-based security action logic 108 generates a security score by combining the threat score and the anomaly score. The hybrid AI analysis-based security action logic 108 performs a security action as a result of the security score satisfying a security threat criterion.

In a second example implementation, the hybrid AI analysis-based security action logic 108 causes a supervised AI model to determine a first extent to which relationships between more than two dynamically changing vectors in a multi-vector representation correspond to first reference relationships associated with a known security threat. The more than two vectors represent respective subsets of telemetry associated with a machine over a sliding window of time. The hybrid AI analysis-based security action logic 108 causes the supervised AI model to determine the first extent by causing the supervised AI model to analyze the relationships and the first reference relationships. The hybrid AI analysis-based security action logic 108 causes an unsupervised AI model to determine a second extent to which the relationships between the more than two dynamically changing vectors differ from second reference relationships associated with a machine type of the machine. The hybrid AI analysis-based security action logic 108 causes the unsupervised AI model to determine the second extent by causing the unsupervised AI model to analyze the relationships and the second reference relationships. The hybrid AI analysis-based security action logic 108 generates a security score by combining a threat score and an anomaly score. The threat score indicates the first extent to which the relationships correspond to the first reference relationships associated with the known security threat. The anomaly score indicates the second extent to which the relationships differ from the second reference relationships associated with the machine type of the machine. The hybrid AI analysis-based security action logic 108 performs a security action as a result of the security score satisfying a security threat criterion.

In a third example implementation, the hybrid AI analysis-based security action logic 108 generates a first vector that represents first attributes of a network connection between the machine and an entity. The hybrid AI analysis-based security action logic 108 generates a second vector that represents second attributes of an operation performed by a process that executes on the machine. The hybrid AI analysis-based security action logic 108 generates a third vector that represents third attributes of a machine type of the machine. The hybrid AI analysis-based security action logic 108 generates a threat score by analyzing relationships between the first vector, the second vector, and the third vector and first reference relationships associated with a known security threat using a supervised AI model. The threat score indicates a first extent to which the relationships correspond to the first reference relationships. The hybrid AI analysis-based security action logic 108 generates an anomaly score by analyzing the relationships between the first vector, the second vector, and the third vector and second reference relationships associated with the machine type of the machine using an unsupervised AI model. The anomaly score indicates a second extent to which the relationships differ from the second reference relationships. The hybrid AI analysis-based security action logic 108 generates a security score by combining the threat score and the anomaly score. The hybrid AI analysis-based security action logic 108 performs a security action as a result of the security score satisfying a security threat criterion.

The hybrid AI analysis-based security action logic 108 may be implemented in various ways to perform a multi-vector correlation using threat and anomaly analyses to assess a real-time security threat, including being implemented in hardware, software, firmware, or any combination thereof. In an aspect, the hybrid AI analysis-based security action logic 108 is implemented as computer program code configured to be executed in one or more processors. In another aspect, at least a portion of the hybrid AI analysis-based security action logic 108 is implemented as hardware logic/electrical circuitry. In an example of this aspect, at least a portion of the hybrid AI analysis-based security action logic 108 is implemented in a field-programmable gate array (FPGA), an application-specific integrated circuit (ASIC), an application-specific standard product (ASSP), a system-on-a-chip system (SoC), and/or a complex programmable logic device (CPLD). In an example, each SoC includes an integrated circuit chip that includes one or more of a processor (a microcontroller, microprocessor, digital signal processor (DSP), etc.), memory, one or more communication interfaces, and/or further circuits and/or embedded firmware to perform its functions.

In an aspect, the hybrid AI analysis-based security action logic 108 is (or is included in) a computer security program and/or a cloud computing program.

The hybrid AI analysis-based security action logic 108 is shown to be incorporated in the first server(s) 106A for illustrative purposes and is not intended to be limiting. It will be recognized that the hybrid AI analysis-based security action logic 108 (or any portion(s) thereof) may be incorporated in any one or more of the servers 106A-106N, any one or more of the user devices 102A-102M, or any combination thereof. In an example, client-side aspects of the hybrid AI analysis-based security action logic 108 are incorporated in one or more of the user devices 102A-102M, and server-side aspects of hybrid AI analysis-based security action logic 108 are incorporated in one or more of the servers 106A-106N.

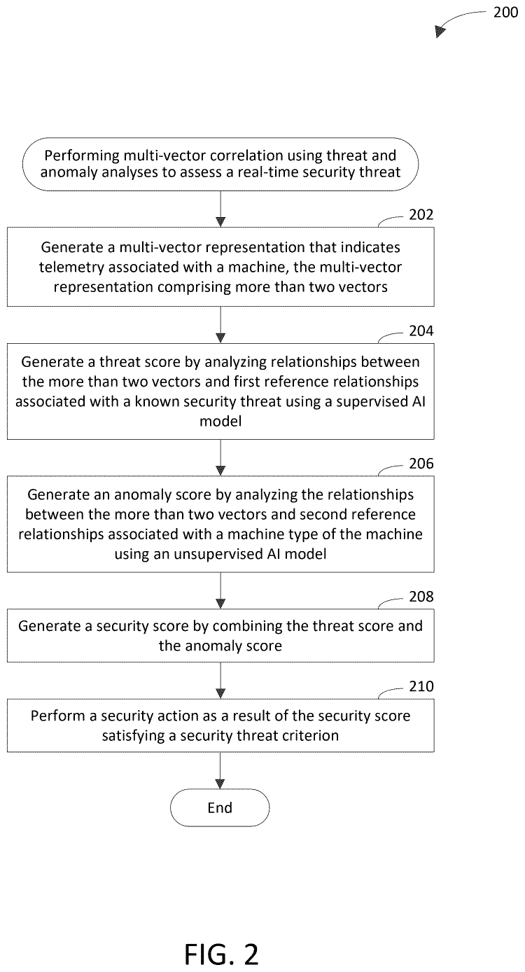

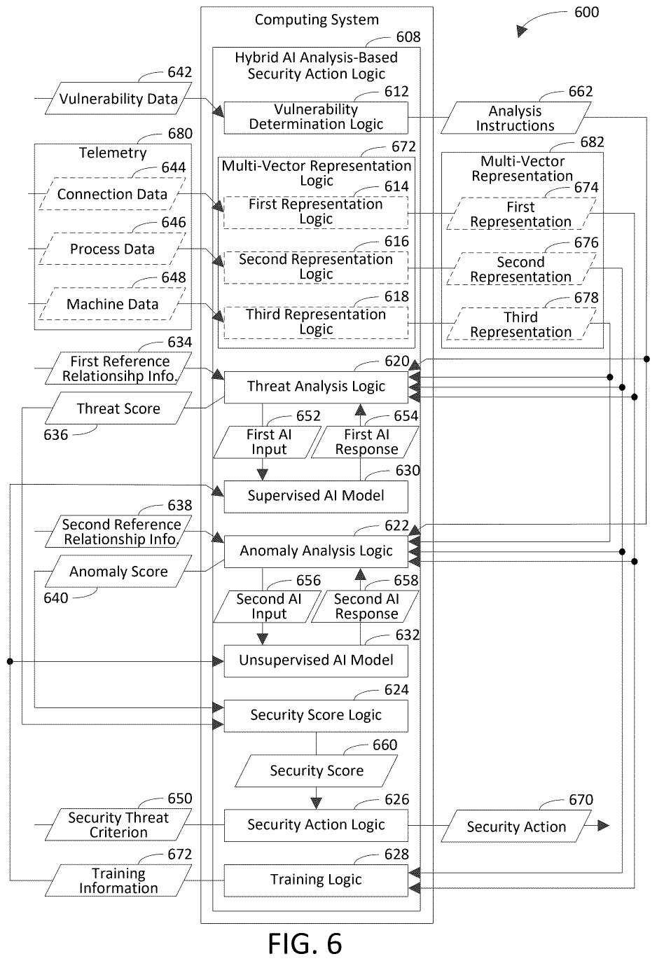

FIGS. 2-5 depict flowcharts 200, 300, 400, and 500 of example methods for performing a security action based on threat and anomaly analyses using connection, process, and machine data in accordance with embodiments. Flowcharts 200, 300, 400, and 500 may be performed by the first server(s) 106A shown in FIG. 1, for example. For illustrative purposes, flowcharts 200, 300, 400, and 500 are described with respect to a computing system 600 shown in FIG. 6, which is an example implementation of the first server(s) 106A. As shown in FIG. 6, the computing system 600 includes hybrid AI analysis-based security action logic 608. The hybrid AI analysis-based security action logic 608 includes vulnerability determination logic 612, multi-vector representation logic 672, threat analysis logic 620, anomaly analysis logic 622, security score logic 624, security action logic 626, training logic 628, a supervised AI model 630, and an unsupervised AI model 632. The multi-vector representation logic 672 includes first representation logic 614, second representation logic 616, and third representation logic 618 for non-limiting illustrative purposes. Further structural and operational embodiments will be apparent to persons skilled in the relevant art(s) based on the discussion regarding flowcharts 200, 300, 400, and 500.

As shown in FIG. 2, the method of flowchart 200 begins at step 202. In step 202, a multi-vector representation is generated. The multi-vector representation indicates (e.g., represents) telemetry associated with a machine. The multi-vector representation comprises more than two vectors. In an aspect, the machine is a physical machine (e.g., a user device or a server). In another aspect, the machine is a virtual machine. In an example implementation, the multi-vector representation logic 672 generates a multi-vector representation 682, which indicates telemetry 680 associated with the machine. The telemetry 680 is shown in FIG. 6 to include connection data 644, process data 646, and machine data 648 for non-limiting illustrative purposes. It will be recognized that the telemetry 680 need not necessarily include the connection data 644, the process data 646, and/or the machine data 648. The multi-vector representation 682 comprises more than two vectors. In an aspect, the multi-vector representation logic 672 analyzes the telemetry 680 to determine attributes associated with the machine. In accordance with this aspect, the multi-vector representation logic 672 uses the attributes associated with the machine to generate the multi-vector representation 682. In an example of this aspect, the multi-vector representation logic 672 generates the more than two vectors using respective subsets of the attributes. In accordance with example, the multi-vector representation logic 672 embeds respective subsets of information regarding the respective subsets of the attributes into the more than two vectors.

In an example embodiment, the more than two vectors comprise at least a first vector, a second vector, and a third vector. In accordance with this embodiment, the first vector represents first attributes of a network connection between a machine and an entity. In further accordance with this embodiment, the second vector represents second attributes of operations performed by a process that executes on the machine. In further accordance with this embodiment, the third vector represents third attributes of a machine type of the machine.

In yet another example embodiment, generating the multi-vector representation at step 202 comprises normalizing the attributes associated with the machine to provide normalized attributes. In accordance with this embodiment, the multi-vector representation is generated at step 202 using the normalized attributes associated with the machine. In an aspect, the first attributes are normalized using a normalization tool. Examples of a normalization tool include but are not limited to a StandardScaler™ tool, a MinMaxScaler™ tool, a RobustScaler™ tool, a Normalizer™ tool, and a MaxAbsScaler™ tool, all of which are developed and distributed by the scikit-learn community.

It will be recognized that the machine may execute any suitable operating system(s). Examples of an operating system include but are not limited to a Linux® operating system, developed by Linus Torvalds and distributed under the GNU Project; a Berkeley Software Distribution™ (BSD) operating system, developed and distributed by the Computer Systems Research Group (CSRG) of the University of California, Berkeley, or descendants thereof; an iOS™ operating system, developed and distributed by Apple Inc.; a Microsoft Windows® operating system, developed and distributed by Microsoft Corporation; and a UNIX™ operating system, developed and distributed by AT&T.

At step 204, a threat score is generated by analyzing relationships between the more than two vectors and first reference relationships associated with a known security threat using a supervised AI model. The threat score indicates a first extent to which the relationships correspond to the first reference relationships. In an aspect, the threat score is generated by analyzing the more than two vectors simultaneously. In another aspect, the threat score is generated by analyzing the more than two vectors within 500 milliseconds, within 100 milliseconds, or within 20 milliseconds of receipt of the more than two vectors. In yet another aspect, the supervised AI model is trained on labeled data. In an example implementation, the threat analysis logic 620 generates a threat score 636 by analyzing relationships between the more than two vectors in the multi-vector representation 682 and first reference relationships using the supervised AI model 630. In accordance with this implementation, the threat score 636 indicates a first extent to which the relationships between the more than two vectors correspond to the first reference relationships 634. In an example, the threat score 636 indicates a similarity between the relationships and the first reference relationships 634.

In an aspect, the threat analysis logic 620 generates the threat score 636 using the supervised AI model 630 by providing a first AI input 652 together with first contextual information to the supervised AI model 630 for analysis. In accordance with this aspect, the first AI input 652 requests a determination of the first extent to which the relationships between the more than two vectors in the multi-vector representation 682 correspond to the first reference relationships. The first contextual information comprises the the multi-vector representation 682 and first reference relationship information 634. The first reference relationship information 634 indicates (e.g., specifies or describes) the first reference relationships. In an example, by providing the first AI input 652 and the first contextual information to the supervised AI model 630, the threat analysis logic 620 causes (e.g., triggers) the supervised AI model 630 to analyze the more than two vectors in the multi-vector representation 682 and the first reference relationship information 634. In accordance with this aspect, the threat analysis logic 620 receives a first AI response 654 from the supervised AI model 630 in response to the first AI input 652.

In an example of this aspect, the first AI response 654 indicates the first extent to which the relationships between the more than two vectors in the multi-vector representation 682 correspond to the first reference relationships. In accordance with this example, the threat analysis logic 620 generates the threat score 636 by configuring the threat score 636 to correspond to the first extent to which the relationships between the more than two vectors in the multi-vector representation 682 correspond to the first reference relationships, as indicated by the first AI response 654.

In another example of this aspect, the first AI input 652 further requests generation of the threat score 636 using the first extent to which the relationships between the more than two vectors in the multi-vector representation 682 correspond to the first reference relationships. In accordance with this example, the first AI response 654 indicates (e.g., includes) the threat score 636. In further accordance with this example, the threat analysis logic 620 generating the threat score 636 using the supervised AI model 630 comprises the threat analysis logic 620 providing the first AI input 652 and the first contextual information to the supervised AI model 630, which causes the supervised AI model 630 to generate the threat score 636. In further accordance with this example, the threat analysis logic 620 generating the threat score 636 using the supervised AI model 630 further comprises the threat analysis logic 620 receiving the first AI response 654, which indicates the threat score 636, from the supervised AI model 630.

In an example embodiment, the machine type of the machine is included among a plurality of machine types. In an aspect, at least a subset of the first reference relationships associated with each machine type differs from at least a subset of the first reference relationships associated with each other machine type. In another aspect, the first reference relationships associated with a particular machine type indicate one or more patterns (e.g., behaviors) associated with a known security threat regarding the particular machine type. In an example of this aspect, the relationships between the more than two vectors indicate pattern(s) associated with the machine. By analyzing the relationships between the more than two vectors and the first reference relationships associated with a known security threat (e.g., regarding the machine type of the machine) using the supervised AI model at step 204, the supervised AI model is caused to determine an extent to which the pattern(s) associated with the machine, as indicated by the relationships, correspond to the one or more patterns associated with the known security threat, as indicated by the first reference relationships.

Examples of a machine type include but are not limited to a web server, a database server, and an application server, all of which are described in further detail above. Following are examples of some patterns that may be identified as being associated with a known security threat and other patterns that may be identified as not being associated with a known security threat for each of the aforementioned machine types. In an aspect, for each machine type, patterns that are identified as being associated with a known security threat are indicated by the first reference relationships associated with the machine type, whereas patterns that are identified as not being associated with a known security threat are not indicated by the first reference relationships associated with the machine type.

In a “web server” machine type example, patterns that are not associated with a known security threat regarding a “web server” machine type include but are not limited to high-volume external connections, thousands of unique IP addresses connecting to ports 80/443, short-lived connections (e.g., <1 second duration), balanced request sizes (e.g., 2-5 kB average), regular DNS query patterns for client IP resolution, large outbound transfers (e.g., downloading images) to multiple clients, heavy traffic during peak hours, and consistent content-type patterns. In accordance with this example, patterns that are associated with a known security threat regarding the “web server” machine type include but are not limited to command and control indicators, long-lived single connection to unusual external IP, regular beaconing patterns (e.g., every 60 seconds), small encrypted packets at regular intervals, connections to newly registered domains, large outbound transfers to unknown hosts, data transfers during unusual hours, HTTP POST requests with abnormal sizes, and DNS tunneling patterns (e.g., large DNS TXT queries).

In a “database server” machine type example, patterns that are not associated with a known security threat regarding a “database server” machine type include but are not limited to replication traffic, constant data exchange between known database nodes, consistent bandwidth utilization, standard database ports (e.g., 3306, 5432, 1521), regular backup transfers (e.g., scheduled, high-volume), stable connection pools from application servers, predictable query patterns, and known source IP addresses within infrastructure. In accordance with this example, patterns that are associated with a known security threat regarding the “database server” machine type include but are not limited to data theft, full table dumps to unknown hosts, sequential scanning patterns, connections from unauthorized sources, unusual query patterns (e.g., full table selects), high CPU utilization with database processes, unexpected outbound connections, unknown processes accessing database files, and connection attempts to mining pools.

In an “application server” machine type example, patterns that are not associated with a known security threat regarding an “application server” machine type include but are not limited to consistent network traffic, authorized access (e.g., successful login attempts from recognized users and devices), stable system configuration, predictable resource usage, known processes, controlled data transfer, and routine user behavior. In accordance with this example, patterns that are associated with a known security threat regarding the “application server” machine type include but are not limited to unusual network traffic (e.g., a sudden spike in network traffic or data transfer rates, especially from unknown or unexpected IP addresses), unauthorized access attempts (e.g., from unusual locations or devices), high resource usage, unknown or suspicious processes running, data exfiltration (e.g., to external locations), and user access to sensitive data or systems not usually accessed.

In an example embodiment, generating the threat score at step 204 comprises determining that an internet protocol (IP) address indicated by a vector in the more than two vectors corresponds to a reference IP address that is associated with a malicious threat. In accordance with this embodiment, generating the threat score at step 204 further comprises incrementing the threat score by a specified (e.g., pre-defined and/or fixed) amount as a result of the IP address indicated by the vector corresponding to the reference IP address that is associated with the malicious threat. In an aspect, the threat score is in a range between zero and one. In an example of this aspect, the specified amount is in a range between 0.05 and 0.3. In another example of this aspect, the specified amount is in a range between 0.05 and 0.25. In yet another example of this aspect, the specified amount is in a range between 0.05 and 0.2. In still another example of this aspect, the specified amount is 0.1, 0.2, or 0.3.

In another example embodiment, generating the threat score at step 204 comprises determining that a vector in the more than two vectors indicates that the machine was previously a target of a security attack. In accordance with this embodiment, generating the threat score at step 208 further comprises incrementing the threat score by a specified amount as a result of the machine previously being the target of the security attack.

At step 206, an anomaly score is generated by analyzing the relationships between the more than two vectors and second reference relationships associated with the machine type of the machine using an unsupervised AI model. The anomaly score indicates a second extent to which the relationships differ from the second reference relationships. In an aspect, the anomaly score is generated by analyzing the more than two vectors simultaneously. In another aspect, the unsupervised AI model is trained on unlabeled data to assist in identifying deviations and novel unknown threats. For instance, supervised learning alone may not be capable of identifying such deviations and novel unknown threats. In an example implementation, the anomaly analysis logic 622 generates an anomaly score 640 by analyzing the relationships between the more than two vectors in the multi-vector representation 682 and second reference relationships 638 associated with the machine type of the machine using the unsupervised AI model 632. In accordance with this implementation, the anomaly score 640 indicates a second extent to which the relationships between the more than two vectors in the multi-vector representation 682 differ from the second reference relationships 638.

In an aspect, the anomaly analysis logic 622 generates the anomaly score 640 using the unsupervised AI model 632 by providing a second AI input 656 together with second contextual information to the unsupervised AI model 632 for analysis. In accordance with this aspect, the second AI input 656 requests a determination of the second extent to which the relationships between the more than two vectors in the multi-vector representation 682 differ from the second reference relationships. The second contextual information comprises the multi-vector representation 682 and second reference relationship information 638. The second reference relationship information 638 indicates (e.g., specifies or describes) the second reference relationships. In an example, by providing the second AI input 656 and the second contextual information to the unsupervised AI model 632, the anomaly analysis logic 622 causes (e.g., triggers) the unsupervised AI model 632 to analyze the more than two vectors in the multi-vector representation 682 and the second reference relationship information 638. In accordance with this aspect, the anomaly analysis logic 622 receives a second AI response 658 from the unsupervised AI model 632 in response to the second AI input 656.

In an example of this aspect, the second AI response 658 indicates the second extent to which the relationships between the more than two vectors in the multi-vector representation 682 differ from the second reference relationships. In accordance with this example, the anomaly analysis logic 622 generates the anomaly score 640 by configuring the anomaly score 640 to correspond to the second extent to which the relationships between the more than two vectors in the multi-vector representation 682 differ from the second reference relationships, as indicated by the second AI response 658.

In another example of this aspect, the second AI input 656 further requests generation of the anomaly score 640 using the second extent to which the relationships between the more than two vectors in the multi-vector representation 682 differ from the second reference relationships. In accordance with this example, the second AI response 658 indicates (e.g., includes) the anomaly score 640. In further accordance with this example, the anomaly analysis logic 622 generating the anomaly score 640 using the unsupervised AI model 632 comprises the anomaly analysis logic 622 providing the second AI input 656 and the second contextual information to the unsupervised AI model 632, which causes the unsupervised AI model 632 to generate the anomaly score 640. In further accordance with this example, the anomaly analysis logic 622 generating the anomaly score 640 using the unsupervised AI model 632 further comprises the anomaly analysis logic 622 receiving the second AI response 658, which indicates the anomaly score 640, from the unsupervised AI model 632.

In an example embodiment, the anomaly score takes into consideration a historical false positive rate associated with the machine type of the machine. A historical false positive rate is a number of false positives generated during a specified period of time. For instance, the specified period of time may be 7 days, 30 days, one month, or three months. In an aspect, a lower historical false positive rate weighs in favor of (e.g., corresponds to) a higher anomaly score. In another aspect, a higher historical false positive rate weighs in favor of a lower anomaly score.

Steps 204 and 206 may be performed in any order. In an aspect, step 204 is performed before step 206. In an example of this aspect, step 204 is completed prior to initiation of step 206. In another aspect, step 206 is performed before step 204. In an example of this aspect, step 206 is completed prior to initiation of step 204. In yet another aspect, step 204 and step 208 temporally overlap. In an example of this aspect, step 204 and step 206 are performed in parallel.

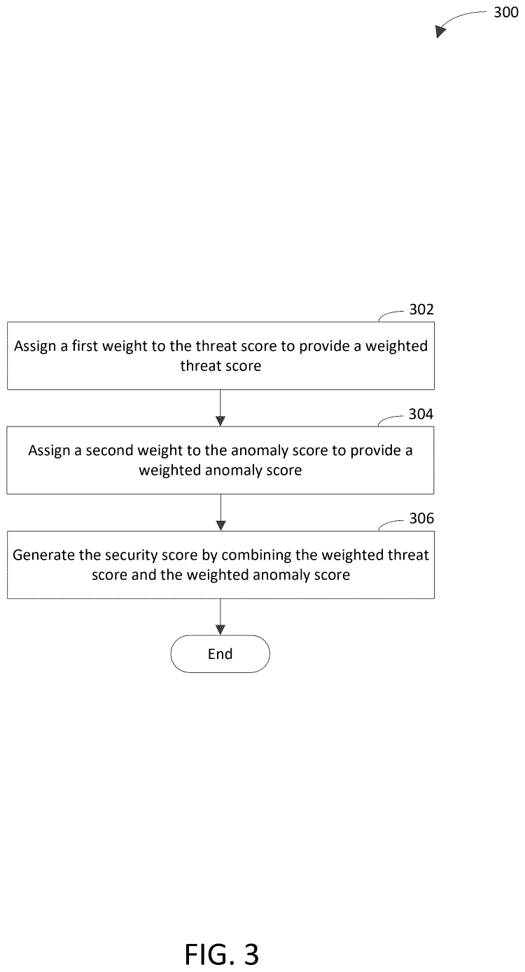

At step 208, a security score is generated by combining the threat score and the anomaly score. In an example, the security score is equal to a sum of the threat score and the anomaly score. In another example, the security score is equal to an average of the threat score and the anomaly score. In yet another example, the security score is generated by applying respective weights to the threat score and the anomaly score, as described below with reference to flowchart 300 in FIG. 3. In still another example, the security score is generated by applying a business rule to the threat score and the anomaly score. In another example, the security score is generated by providing the threat score and the anomaly score as inputs to a plurality of machine learning models in accordance with a machine learning fusion technique. A machine learning fusion technique is a technique that utilizes multiple machine learning models or techniques to derive information from data. In an example, the machine learning fusion technique generates a unitary (e.g., combined or aggregated) output from respective outputs of the multiple machine learning models or techniques. By utilizing the multiple machine learning models or techniques, the machine learning fusion technique may derive information that is more accurate, precise, reliable, consistent, and/or useful than information derived using a single machine learning model or technique. In an example implementation, the security score logic 624 generates a security score 660 by combining the threat score 636 and the anomaly score 640.

At step 210, a security action is performed as a result of the security score satisfying a security threat criterion. A security action is an action that is performed in response to (e.g., to address) a security threat. In an aspect, performance of the security action is triggered by an identification of the security threat. In accordance with this aspect, the security score satisfying the security threat criterion indicates that the security threat is identified. In another aspect, the security action is configured to increase security of a system (e.g., a resource in or utilized by the system) and/or a user of the system. Examples of a security action include but are not limited to isolating a machine, containing (e.g., quarantining) a user, containing an account, containing a file, containing a folder, stopping a virtual machine, rotating (e.g., changing) a secret (e.g., a password, an application programming interface (API) key, an encryption key, or other credential). In an aspect, performing the security action at step 210 includes triggering (e.g., automatically triggering) execution of an instruction (e.g., a computer-readable instruction) that causes the security action to be performed. In another aspect, performing the security action at step 210 includes executing (e.g., automatically executing) an instruction that triggers performance of the security action. In yet another aspect, the security action is predefined (i.e., defined prior to a determination that the security score satisfies the security threat criterion). In an example of this aspect, the security action is performed without human intervention.

A security threat criterion is a condition that is to be satisfied (e.g., must be satisfied) to cause (e.g., trigger) performance of a security action in response to a security threat. In an aspect, satisfaction of the condition indicates (e.g., triggers a determination) that the security threat exists. In another aspect, satisfaction of the condition triggers the performance of the security action. In yet another aspect, the security threat criterion requires the security score to be greater than or equal to a threshold score. In still another aspect, the security threat criterion requires the security score to be in a range between a lower threshold score and a higher threshold score. In an example of this aspect, the security score being in a first range triggers performance of a first security action; the security score being in a second range triggers performance of a second security action that is different from the first security action; the security score being in a third range triggers performance of a third security action that is different from the first security action and the second security action, and so on. In an example implementation, the security action logic 626 performs a security action 670 as a result of the security score 660 satisfying a security threat criterion 650.

In an example embodiment, performing the security action at step 210 comprises providing a security alert to an administrative user of the machine as a result of the security score being greater than or equal to a threshold score. In an aspect, the security score is in a range between zero and one. In an example of this aspect, the threshold score is in a range between 0.5 and 1.0. In another example of this aspect, the threshold score is in a range between 0.6 and 1.0. In yet another example of this aspect, the threshold score is in a range between 0.7 and 1.0. In still another example of this aspect, the threshold score is in a range between 0.8 and 1.0. In another example of this aspect, the threshold score is 0.6, 0.7, 0.8, or 0.9. In yet another aspect, the security alert is provided in real-time (e.g., on-the-fly) as a result of the security score being greater than or equal to the threshold score.

In another example embodiment, a vector in the more than two vectors represents attributes of operations performed by processes that execute on the machine over a specified duration of time. In accordance with this embodiment, the vector indicates that a number of the operations performed by the processes that execute on the machine over the specified duration of time that correspond to a same network connection between the machine and an entity is greater than or equal to a threshold number. In further accordance with this embodiment, the threshold number is greater than or equal to two. In an example, the threshold number is 2, 3, 4, or 5. In further accordance with this embodiment, performing the security action at step 210 comprises providing a security alert to an owner of the machine as a result of the number of the operations performed by the processes that execute on the machine over the specified duration of time that correspond to the same network connection between the machine and the entity being greater than or equal to the threshold number. In another aspect, the security alert specifies the number of the operations performed by the processes that execute on the machine over the specified duration of time that correspond to the same network connection between the machine and the entity. In another aspect, the security alert specifies that the number of the operations performed by the processes that execute on the machine over the specified duration of time that correspond to the same network connection between the machine and the entity is greater than or equal to the threshold number.

In yet another example embodiment, a vector in the more than two vectors represents attributes of operations performed by processes that execute on the machine over a specified duration of time. In accordance with this embodiment, the vector indicates that a number of the operations performed by the processes that execute on the machine over the specified duration of time that correspond to a same network connection between the machine and an entity is greater than or equal to a threshold number. In further accordance with this embodiment, the threshold number is greater than or equal to two. In further accordance with this embodiment, performing the security action at step 210 comprises adding an internet protocol (IP) address associated with the same network connection to a list of malicious IP addresses as a result of the number of the operations performed by the processes that execute on the machine over the specified duration of time that correspond to the same network connection between the machine and the entity being greater than or equal to the threshold number. A malicious IP address is an IP address that is deemed to be associated with a security threat. In an aspect, the malicious IP address is associated with a known security threat.

In still another example embodiment, performing the security action at step 210 comprises terminating a process that executes on the machine as a result of the security score being greater than or equal to a threshold score. In an aspect, the process is terminated at runtime of the process.

In a sliding window example embodiment, the more than two vectors comprise more than two dynamically changing vectors. A dynamically changing vector is a vector that changes with passage of time. In accordance with this aspect, generating the threat score at step 204 comprises analyzing the relationships between the more than two dynamically changing vectors and the first reference relationships using the supervised AI model. In further accordance with this embodiment, generating the anomaly score at step 206 comprises analyzing the relationships between the more than two dynamically changing vectors and the second reference relationships using the unsupervised AI model.

Steps 202, 204, 206, 208, and/or 210 are described above with regard to “a machine” for a illustrative purposes and are not intended to be limiting. It will be recognized that 202, 204, 206, 208, and/or 210 are applicable to any suitable number of machines (e.g., hundreds, thousands, or millions of machines). In an example implementation, the telemetry indicated by the multi-vector representation is associated with multiple machines. In accordance with this implementation, the second reference relationships are associated with machine types of the machines. In an aspect of this implementation, the multi-vector representation is generated using information gathered in real-time (e.g., on-the-fly) from the machines. In an example of this aspect, the information is gathered using agents running on the machines. In an example embodiment, the information is forwarded to a central location at which the supervised AI model and the unsupervised AI model may access the information. For instance, the information may be forwarded to a server having relatively large compute and storage capacity at the central location. By having the supervised AI model and the unsupervised AI model access the information from the server at the central location, consumption of compute and storage bandwidth of the machines may be mitigated. In another example embodiment, instances of the supervised AI model and the unsupervised AI model are executed on the respective machines. In accordance with this embodiment, the portions of the information that are gathered from the respective machines are processed by the instances of the supervised AI model and the unsupervised AI model executing on the respective machines. By having the instances of the supervised AI model and the unsupervised AI model that execute on the respective machines process the respective portions of the information, latency associated with processing the information may be reduced.

In some example embodiments, one or more steps 202, 204, 206, 208, and/or 210 of flowchart 200 may not be performed. Moreover, steps in addition to or in lieu of steps 202, 204, 206, 208, and/or 210 may be performed. For instance, in an aspect of the sliding window embodiment mentioned above, the more than two dynamically changing vectors comprise at least a first dynamically changing vector and a second dynamically changing vector. In accordance with this aspect, the first dynamically changing vector represents first telemetry associated with the machine over a sliding window of time. For instance, the first telemetry may indicate network connections between the machine and entities over the sliding window of time. A sliding window of time is a window of time having a starting time and an ending time that increment with passage of time. In an example, the sliding window of time is a fixed duration of time having an ending time that is continuously or iteratively updated to be a current time. In an accordance with this example, the ending time is equal to the start time plus the fixed duration of time. In further accordance with this aspect, the second dynamically changing vector represents second telemetry associated with the machine over the sliding window of time. For instance, the second telemetry may indicate operations performed by processes that execute on the machine over the sliding window of time. In further accordance with this aspect, the method of flowchart 200 further comprises iteratively train the supervised AI model and the unsupervised AI model over a plurality of iterations in which a starting time of the sliding window of time is incremented by a specified amount of time in successive iterations of the plurality of iterations. In an example implementation, the training logic 628 iteratively trains the supervised AI model 630 and the unsupervised AI model 632 over a plurality of iterations using the sliding window technique. In an aspect, the training logic 628 iteratively trains the supervised AI model 630 and the unsupervised AI model 632 over the plurality of iterations by providing training information 672 to the supervised AI model 630 and the unsupervised AI model 632.

In an example vulnerability embodiment, the method of flowchart 200 further comprises determining that the machine is vulnerable to a security threat as a result of vulnerability data indicating that the machine is vulnerable to the security threat. In an aspect, a determination is made that the machine is vulnerable to the security threat by calling an application programming interface (API) that provides access to the vulnerability data. In an example implementation, the vulnerability determination logic 612 determines that the machine is vulnerable to the security threat as a result of vulnerability data 642 indicating that the machine is vulnerable to the security threat. The vulnerability determination logic 612 generates analysis instructions 662 as a result of the vulnerability determination logic 612 determining that the machine is vulnerable to the security threat. The analysis instructions 662 include a first instruction that instructs the threat analysis logic 620 to generate the threat score 636. The analysis instructions 662 further include a second instruction that instructs the anomaly analysis logic 622 to generate the anomaly score 640.

In accordance with the vulnerability embodiment, generating the threat score at step 204 comprises triggering analysis of the relationships between the more than two vectors and the first reference relationships using the supervised AI model in response to the vulnerability data indicating that the machine is vulnerable to the security threat. In an example implementation, the threat analysis logic 620 generates the threat score 636 using the supervised AI model 630 by triggering the supervised AI model 630 to analyze the relationships between the more than two vectors in the multi-vector representation 682 and the first reference relationships in response to receipt of the first instruction, which is included in the analysis instructions 662. In an aspect, the threat analysis logic 620 triggers the supervised AI model 630 to perform the analysis as a result of the first instruction instructing the threat analysis logic 620 to generate the threat score 636.

In further accordance with the vulnerability embodiment, generating the anomaly score at step 210 comprises triggering analysis of the relationships between the more than two vectors and the second reference relationships using the supervised AI model in response to the vulnerability data indicating that the machine is vulnerable to the security threat. In an example implementation, the anomaly analysis logic 622 generates the anomaly score 640 using the unsupervised AI model 632 by triggering the unsupervised AI model 632 to analyze the relationships between the more than two vectors in the multi-vector representation 682 and the second reference relationships in response to receipt of the second instruction, which is included in the analysis instructions 662. In an aspect, the anomaly analysis logic 622 triggers the unsupervised AI model 632 to perform the analysis as a result of the second instruction instructing the anomaly analysis logic 622 to generate the anomaly score 640.

In an example weighting embodiment, the method of flowchart 200 includes one or more of the steps shown in flowchart 300 of FIG. 3. In an aspect, one or more of the steps shown in flowchart 300 are included in step 212 of flowchart 200. As shown in FIG. 3, the method of flowchart 300 begins at step 302. In step 302, a first weight is assigned to the threat score to provide a weighted threat score. In an example implementation, the security score logic 624 assigns the first weight to the threat score 636 to provide the weighted threat score.

At step 304, a second weight is assigned to the anomaly score to provide a weighted anomaly score. The first weight is greater than the second weight. In an example implementation, the security score logic 624 assigns the second weight to the anomaly score 640 to provide the weighted anomaly score. In an aspect, a sum of the first weight and the second weight is equal to 100%. In another aspect, the first weight is greater than 50%, and the second weight is less than 50%. In yet another aspect, the first weight is greater than or equal to 60%, and the second weight is less than or equal to 40%. In still another aspect, the first weight is greater than or equal to 70%, and the second weight is less than or equal to 30%. In another aspect, the first weight is greater than or equal to 80%, and the second weight is less than or equal to 20%.

At step 306, the security score is generated by combining the weighted threat score and the weighted anomaly score. In an example implementation, the security score logic 624 generates the security score 660 by combining the weighted threat score and the weighted anomaly score.

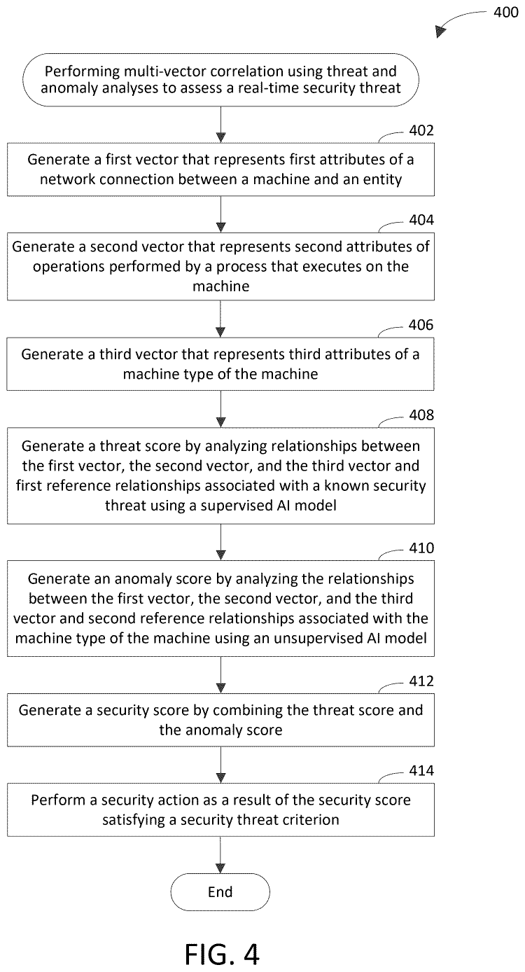

As shown in FIG. 4, the method of flowchart 400 begins at step 402. In step 402, a first vector is generated. The first vector represents first attributes of a network connection between a machine and an entity. In an aspect, the machine is a physical machine (e.g., a user device or a server). In another aspect, the machine is a virtual machine. In yet another aspect, the entity is a physical machine (e.g., a user device or a server). In still another aspect, the entity is a virtual machine. In another aspect, the network connection is established in response to a network call from the entity to the machine. In yet another aspect, the network connection is established in response to a network call from the machine to the entity. In an example implementation, the first representation logic 614 generates a first representation 674, which represents the first attributes of the network connection between the machine and the entity. In accordance with this implementation, the first representation 674 is configured to be the first vector. In an aspect, connection data 644 indicates (e.g., specifies or describes) the first attributes of the network connection between the machine and the entity. In accordance with this aspect, the first representation logic 614 analyzes the connection data 644 to determine the first attributes. In further accordance with this aspect, the first representation logic 614 uses the first attributes, as indicated by the connection data 644, to generate the first representation 674 of the first attributes. In an example of this aspect, the first representation logic 614 embeds information regarding the first attributes into the first vector.

In an example embodiment, generating the first vector at step 402 comprises normalizing the first attributes to provide normalized first attributes. In accordance with this embodiment, the first vector is generated at step 402 using the normalized first attributes. In an aspect, the first attributes are normalized using a normalization tool.

At step 404, a second vector is generated. The second vector represents second attributes of operations performed by a process that executes on the machine. In an aspect, the process is associated with the network connection between the machine and the entity. In an example implementation, the second representation logic 616 generates a second representation 676, which represents the second attributes of the operations performed by the process that executes on the machine. In accordance with this implementation, the second representation 676 is configured to be the second vector. In an aspect, process data 646 indicates (e.g., specifies or describes) the second attributes of the operations performed by the process that executes on the machine. In accordance with this aspect, the second representation logic 616 analyzes the process data 646 to determine the second attributes. In further accordance with this aspect, the second representation logic 616 uses the second attributes, as indicated by the process data 646, to generate the second representation 676 of the second attributes. In an example of this aspect, the second representation logic 616 embeds information regarding the second attributes into the second vector.

In an example embodiment, generating the second vector at step 404 comprises normalizing the second attributes to provide normalized second attributes. In accordance with this embodiment, the second vector is generated at step 404 using the normalized second attributes. In an aspect, the second attributes are normalized using a normalization tool.

At step 406, a third vector is generated. The third vector represents third attributes of a machine type of the machine. In an example implementation, the third representation logic 618 generates a third representation 678, which represents the third attributes of the machine type of the machine. In accordance with this implementation, the third representation 678 is configured to be the third vector. In an aspect, machine data 648 indicates (e.g., specifies or describes) the third attributes of the machine type of the machine. In accordance with this aspect, the third representation logic 618 analyzes the machine data 648 to determine the third attributes. In further accordance with this aspect, the third representation logic 618 uses the third attributes, as indicated by the machine data 648, to generate the third representation 678 of the third attributes. In an example of this aspect, the third representation logic 618 embeds information regarding the third attributes into the third vector.

In an example embodiment, generating the third vector at step 406 comprises normalizing the third attributes to provide normalized third attributes. In accordance with this embodiment, the third vector is generated at step 406 using the normalized third attributes. In an aspect, the third attributes are normalized using a normalization tool.

At step 408, a threat score is generated by analyzing relationships between the first vector, the second vector, and the third vector and first reference relationships associated with a known security threat using a supervised AI model. The threat score indicates a first extent to which the relationships correspond to the first reference relationships. In an aspect, the threat score is generated by analyzing the first vector, the second vector, and the third vector simultaneously. In another aspect, the threat score is generated by analyzing the first vector, the second vector, and the third vector within 500 milliseconds, within 100 milliseconds, or within 20 milliseconds of receipt of the first vector, the second vector, and the third vector. In yet another aspect, the supervised AI model is trained on labeled data. In an example implementation, the threat analysis logic 620 generates a threat score 636 by analyzing relationships between the first representation 674, the second representation 676, and the third representation 678 and first reference relationships using the supervised AI model 630. In accordance with this implementation, the threat score 636 indicates a first extent to which the relationships between the first representation 674, the second representation 676, and the third representation 678 correspond to the first reference relationships 634. In an example, the threat score 636 indicates a similarity between the relationships and the first reference relationships 634.

In an aspect, the threat analysis logic 620 generates the threat score 636 using the supervised AI model 630 by providing a first AI input 652 together with first contextual information to the supervised AI model 630 for analysis. In accordance with this aspect, the first AI input 652 requests a determination of the first extent to which the relationships between the first representation 674, the second representation 676, and the third representation 678 correspond to the first reference relationships. The first contextual information comprises the first representation 674, the second representation 676, the third representation 678, and first reference relationship information 634. The first reference relationship information 634 indicates (e.g., specifies or describes) the first reference relationships. In an example, by providing the first AI input 652 and the first contextual information to the supervised AI model 630, the threat analysis logic 620 causes (e.g., triggers) the supervised AI model 630 to analyze the first representation 674, the second representation 676, the third representation 678, and the first reference relationship information 634. In accordance with this aspect, the threat analysis logic 620 receives a first AI response 654 from the supervised AI model 630 in response to the first AI input 652.

In an example of this aspect, the first AI response 654 indicates the first extent to which the relationships between the first representation 674, the second representation 676, and the third representation 678 correspond to the first reference relationships. In accordance with this example, the threat analysis logic 620 generates the threat score 636 by configuring the threat score 636 to correspond to the first extent to which the relationships between the first representation 674, the second representation 676, and the third representation 678 correspond to the first reference relationships, as indicated by the first AI response 654.

In another example of this aspect, the first AI input 652 further requests generation of the threat score 636 using the first extent to which the relationships between the first representation 674, the second representation 676, and the third representation 678 correspond to the first reference relationships. In accordance with this example, the first AI response 654 indicates (e.g., includes) the threat score 636. In further accordance with this example, the threat analysis logic 620 generating the threat score 636 using the supervised AI model 630 comprises the threat analysis logic 620 providing the first AI input 652 and the first contextual information to the supervised AI model 630, which causes the supervised AI model 630 to generate the threat score 636. In further accordance with this example, the threat analysis logic 620 generating the threat score 636 using the supervised AI model 630 further comprises the threat analysis logic 620 receiving the first AI response 654, which indicates the threat score 636, from the supervised AI model 630.

In an example embodiment, the machine type of the machine is included among a plurality of machine types. In an aspect, at least a subset of the first reference relationships associated with each machine type differs from at least a subset of the first reference relationships associated with each other machine type. In another aspect, the first reference relationships associated with a particular machine type indicate one or more patterns (e.g., behaviors) associated with a known security threat regarding the particular machine type. In an example of this aspect, the relationships between the first vector, the second vector, and the third vector indicate pattern(s) associated with the machine. By analyzing the relationships between the first vector, the second vector, and the third vector and the first reference relationships associated with a known security threat (e.g., regarding the machine type of the machine) using the supervised AI model at step 408, the supervised AI model is caused to determine an extent to which the pattern(s) associated with the machine, as indicated by the relationships, correspond to the one or more patterns associated with the known security threat, as indicated by the first reference relationships.

In an example embodiment, generating the threat score at step 408 comprises determining that an internet protocol (IP) address indicated by the first vector corresponds to a reference IP address that is associated with a malicious threat. In accordance with this embodiment, generating the threat score at step 408 further comprises incrementing the threat score by a specified (e.g., pre-defined and/or fixed) amount as a result of the IP address indicated by the first vector corresponding to the reference IP address that is associated with the malicious threat. In an aspect, the threat score is in a range between zero and one. In an example of this aspect, the specified amount is in a range between 0.05 and 0.3. In another example of this aspect, the specified amount is in a range between 0.05 and 0.25. In yet another example of this aspect, the specified amount is in a range between 0.05 and 0.2. In still another example of this aspect, the specified amount is 0.1, 0.2, or 0.3.

In another example embodiment, generating the threat score at step 408 comprises determining that the third vector indicates that the machine was previously a target of a security attack. In accordance with this embodiment, generating the threat score at step 408 further comprises incrementing the threat score by a specified amount as a result of the machine previously being the target of the security attack.

At step 410, an anomaly score is generated by analyzing the relationships between the first vector, the second vector, and the third vector and second reference relationships associated with the machine type of the machine using an unsupervised AI model. The anomaly score indicates a second extent to which the relationships differ from the second reference relationships. In an aspect, the anomaly score is generated by analyzing the first vector, the second vector, and the third vector simultaneously. In another aspect, the unsupervised AI model is trained on unlabeled data to assist in identifying deviations and novel unknown threats. For instance, supervised learning alone may not be capable of identifying such deviations and novel unknown threats. In an example implementation, the anomaly analysis logic 622 generates an anomaly score 640 by analyzing the relationships between the first representation 674, the second representation 676, and the third representation 678 and second reference relationships 638 associated with the machine type of the machine using the unsupervised AI model 632. In accordance with this implementation, the anomaly score 640 indicates a second extent to which the relationships between the first representation 674, the second representation 676, and the third representation 678 differ from the second reference relationships 638.

In an aspect, the anomaly analysis logic 622 generates the anomaly score 640 using the unsupervised AI model 632 by providing a second AI input 656 together with second contextual information to the unsupervised AI model 632 for analysis. In accordance with this aspect, the second AI input 656 requests a determination of the second extent to which the relationships between the first representation 674, the second representation 676, and the third representation 678 differ from the second reference relationships. The second contextual information comprises the first representation 674, the second representation 676, the third representation 678, and second reference relationship information 638. The second reference relationship information 638 indicates (e.g., specifies or describes) the second reference relationships. In an example, by providing the second AI input 656 and the second contextual information to the unsupervised AI model 632, the anomaly analysis logic 622 causes (e.g., triggers) the unsupervised AI model 632 to analyze the first representation 674, the second representation 676, the third representation 678, and the second reference relationship information 638. In accordance with this aspect, the anomaly analysis logic 622 receives a second AI response 658 from the unsupervised AI model 632 in response to the second AI input 656.

In an example of this aspect, the second AI response 658 indicates the second extent to which the relationships between the first representation 674, the second representation 676, and the third representation 678 differ from the second reference relationships. In accordance with this example, the anomaly analysis logic 622 generates the anomaly score 640 by configuring the anomaly score 640 to correspond to the second extent to which the relationships between the first representation 674, the second representation 676, and the third representation 678 differ from the second reference relationships, as indicated by the second AI response 658.

In another example of this aspect, the second AI input 656 further requests generation of the anomaly score 640 using the second extent to which the relationships between the first representation 674, the second representation 676, and the third representation 678 differ from the second reference relationships. In accordance with this example, the second AI response 658 indicates (e.g., includes) the anomaly score 640. In further accordance with this example, the anomaly analysis logic 622 generating the anomaly score 640 using the unsupervised AI model 632 comprises the anomaly analysis logic 622 providing the second AI input 656 and the second contextual information to the unsupervised AI model 632, which causes the unsupervised AI model 632 to generate the anomaly score 640. In further accordance with this example, the anomaly analysis logic 622 generating the anomaly score 640 using the unsupervised AI model 632 further comprises the anomaly analysis logic 622 receiving the second AI response 658, which indicates the anomaly score 640, from the unsupervised AI model 632.

In an example embodiment, the anomaly score takes into consideration a historical false positive rate associated with the machine type of the machine.

Steps 408 and 410 may be performed in any order. In an aspect, step 408 is performed before step 410. In an example of this aspect, step 408 is completed prior to initiation of step 410. In another aspect, step 410 is performed before step 408. In an example of this aspect, step 410 is completed prior to initiation of step 408. In yet another aspect, step 408 and step 410 temporally overlap. In an example of this aspect, step 408 and step 410 are performed in parallel.

At step 412, a security score is generated by combining the threat score and the anomaly score. In an example, the security score is equal to a sum of the threat score and the anomaly score. In another example, the security score is equal to an average of the threat score and the anomaly score. In yet another example, the security score is generated by applying respective weights to the threat score and the anomaly score, as described above with reference to flowchart 300 in FIG. 3. In still another example, the security score is generated by applying a business rule to the threat score and the anomaly score. In another example, the security score is generated by providing the threat score and the anomaly score as inputs to a plurality of machine learning models in accordance with a machine learning fusion technique. In an example implementation, the security score logic 624 generates a security score 660 by combining the threat score 636 and the anomaly score 640.

At step 414, a security action is performed as a result of the security score satisfying a security threat criterion. In an aspect, performance of the security action is triggered by an identification of the security threat. In accordance with this aspect, the security score satisfying the security threat criterion indicates that the security threat is identified. In another aspect, the security action is configured to increase security of a system (e.g., a resource in or utilized by the system) and/or a user of the system. In an aspect, performing the security action at step 414 includes triggering (e.g., automatically triggering) execution of an instruction (e.g., a computer-readable instruction) that causes the security action to be performed. In another aspect, performing the security action at step 414 includes executing (e.g., automatically executing) an instruction that triggers performance of the security action. In yet another aspect, the security action is predefined (i.e., defined prior to a determination that the security score satisfies the security threat criterion). In an example of this aspect, the security action is performed without human intervention. In an example implementation, the security action logic 626 performs a security action 670 as a result of the security score 660 satisfying a security threat criterion 650.

In an example embodiment, performing the security action at step 414 comprises providing a security alert to an administrative user of the machine as a result of the security score being greater than or equal to a threshold score. In an aspect, the security score is in a range between zero and one. In an example of this aspect, the threshold score is in a range between 0.5 and 1.0. In another example of this aspect, the threshold score is in a range between 0.6 and 1.0. In yet another example of this aspect, the threshold score is in a range between 0.7 and 1.0. In still another example of this aspect, the threshold score is in a range between 0.8 and 1.0. In another example of this aspect, the threshold score is 0.6, 0.7, 0.8, or 0.9. In yet another aspect, the security alert is provided in real-time (e.g., on-the-fly) as a result of the security score being greater than or equal to the threshold score.

In another example embodiment, the second vector represents the second attributes of operations performed by processes that execute on the machine over a specified duration of time. In accordance with this embodiment, the second vector indicates that a number of the operations performed by the processes that execute on the machine over the specified duration of time that correspond to a same network connection between the machine and the entity is greater than or equal to a threshold number. In further accordance with this embodiment, the threshold number is greater than or equal to two. In an example, the threshold number is 2, 3, 4, or 5. In further accordance with this embodiment, performing the security action at step 414 comprises providing a security alert to an owner of the machine as a result of the number of the operations performed by the processes that execute on the machine over the specified duration of time that correspond to the same network connection between the machine and the entity being greater than or equal to the threshold number. In another aspect, the security alert specifies the number of the operations performed by the processes that execute on the machine over the specified duration of time that correspond to the same network connection between the machine and the entity. In another aspect, the security alert specifies that the number of the operations performed by the processes that execute on the machine over the specified duration of time that correspond to the same network connection between the machine and the entity is greater than or equal to the threshold number.

In yet another example embodiment, the second vector represents the second attributes of operations performed by processes that execute on the machine over a specified duration of time. In accordance with this embodiment, the second vector indicates that a number of the operations performed by the processes that execute on the machine over the specified duration of time that correspond to a same network connection between the machine and the entity is greater than or equal to a threshold number. In further accordance with this embodiment, the threshold number is greater than or equal to two. In further accordance with this embodiment, performing the security action at step 414 comprises adding an internet protocol (IP) address associated with the same network connection to a list of malicious IP addresses as a result of the number of the operations performed by the processes that execute on the machine over the specified duration of time that correspond to the same network connection between the machine and the entity being greater than or equal to the threshold number.

In still another example embodiment, performing the security action at step 414 comprises terminating the process as a result of the security score being greater than or equal to a threshold score. In an aspect, the process is terminated at runtime of the process.

In a sliding window example embodiment, generating the first vector at step 402 comprises generating a first dynamically changing vector that represents the first attributes of network connections between the machine and entities over a sliding window of time. In accordance with this embodiment, generating the second vector at step 404 comprises generating a second dynamically changing vector that represents the second attributes of the operations performed by the processes that execute on the machine over the sliding window of time. In further accordance with this embodiment, generating the threat score at step 408 comprises analyzing the relationships between the first dynamically changing vector, the second dynamically changing vector, and the third vector and the first reference relationships using the supervised AI model. In further accordance with this embodiment, generating the anomaly score at step 410 comprises analyzing the relationships between the first dynamically changing vector, the second dynamically changing vector, and the third vector and the second reference relationships using the unsupervised AI model.

Steps 402, 404, 406, 408, 410, 412, and/or 414 are described above with regard to “a machine” for a illustrative purposes and are not intended to be limiting. It will be recognized that 402, 404, 406, 408, 410, 412, and/or 414 are applicable to any suitable number of machines (e.g., hundreds, thousands, or millions of machines). In an example implementation, the first vector, which is generated at step 402, represents first attributes of network connections between multiple machines and one or more entities. In accordance with this implementation, the second vector, which is generated at step 404, represents second attributes of operations performed by processes that execute on the machines. In further accordance with this implementation, the third vector, which is generated at step 406, represents third attributes of machine types of the machines. In further accordance with this implementation, the anomaly score is generated at step 410 by analyzing the relationships between the first vector, the second vector, and the third vector and second reference relationships associated with the machine types of the machines using the unsupervised AI model.

In an aspect of this implementation, the first attributes, the second attributes, and the third attributes are determined from information gathered in real-time (e.g., on-the-fly) from the machines. In an example of this aspect, the information is gathered using agents running on the machines. In an example embodiment, the information is forwarded to a central location at which the supervised AI model and the unsupervised AI model may access the information. In another example embodiment, instances of the supervised AI model and the unsupervised AI model are executed on the respective machines.

In some example embodiments, one or more steps 402, 404, 406, 408, 410, 412, and/or 414 of flowchart 400 may not be performed. Moreover, steps in addition to or in lieu of steps 402, 404, 406, 408, 410, 412, and/or 414 may be performed. For instance, in an example Linux® embodiment, generating the first vector at step 402 comprises generating the first vector that represents the first attributes of the network connection between the machine, which executes a Linux® operating system, and the entity. In accordance with the Linux® embodiment, generating the second vector at step 404 comprises generating the second vector that represents the second attributes of the operations performed by the process that executes on the Linux® operating system of the machine. In an aspect of this embodiment, the method of flowchart 400 further comprises gathering connection data, which indicates the first attributes of the network connection, using a BPF tracing technique. In an example implementation, the first representation logic 614 gathers the connection data 644. In accordance with this aspect, the method of flowchart 400 further comprises gathering process data, which indicates the second attributes of the operations performed by the process, using a BPF tracing technique. In an example implementation, the second representation logic 616 gathers the process data 646. Iin an example, a user (e.g., an admin user) writes a user-defined BPF program to implement the BPF tracing technique using any of a variety of open-source tools, including but not limited to BPF compiler collection (bcc), bpftrace, or ebpf-go. In accordance with this example, the program is compiled and loaded into the kernel space of the machine. In further accordance with this example, the BPF program that is written by the user is used to gather the connection data and the process data.

In an example vulnerability embodiment, the method of flowchart 400 further comprises determining that the machine is vulnerable to a security threat as a result of vulnerability data indicating that the machine is vulnerable to the security threat. In an aspect, a determination is made that the machine is vulnerable to the security threat by calling an application programming interface (API) that provides access to the vulnerability data. In an example implementation, the vulnerability determination logic 612 determines that the machine is vulnerable to the security threat as a result of vulnerability data 642 indicating that the machine is vulnerable to the security threat. The vulnerability determination logic 612 generates analysis instructions 662 as a result of the vulnerability determination logic 612 determining that the machine is vulnerable to the security threat. The analysis instructions 662 include a first instruction that instructs the threat analysis logic 620 to generate the threat score 636. The analysis instructions 662 further include a second instruction that instructs the anomaly analysis logic 622 to generate the anomaly score 640.

In accordance with the vulnerability embodiment, generating the threat score at step 408 comprises triggering analysis of the relationships between the first vector, the second vector, and the third vector and the first reference relationships using the supervised AI model in response to the vulnerability data indicating that the machine is vulnerable to the security threat. In an example implementation, the threat analysis logic 620 generates the threat score 636 using the supervised AI model 630 by triggering the supervised AI model 630 to analyze the relationships between the first representation 674, the second representation 676, and the third representation 678 and the first reference relationships in response to receipt of the first instruction, which is included in the analysis instructions 662. In an aspect, the threat analysis logic 620 triggers the supervised AI model 630 to perform the analysis as a result of the first instruction instructing the threat analysis logic 620 to generate the threat score 636.

In further accordance with the vulnerability embodiment, generating the anomaly score at step 410 comprises triggering analysis of the relationships between the first vector, the second vector, and the third vector and the second reference relationships using the supervised AI model in response to the vulnerability data indicating that the machine is vulnerable to the security threat. In an example implementation, the anomaly analysis logic 622 generates the anomaly score 640 using the unsupervised AI model 632 by triggering the unsupervised AI model 632 to analyze the relationships between the first representation 674, the second representation 676, and the third representation 678 and the second reference relationships in response to receipt of the second instruction, which is included in the analysis instructions 662. In an aspect, the anomaly analysis logic 622 triggers the unsupervised AI model 632 to perform the analysis as a result of the second instruction instructing the anomaly analysis logic 622 to generate the anomaly score 640.

In an example weighting embodiment, the method of flowchart 400 includes one or more of the steps shown in flowchart 300 of FIG. 3. In an aspect, one or more of the steps shown in flowchart 300 are included in step 412 of flowchart 400.

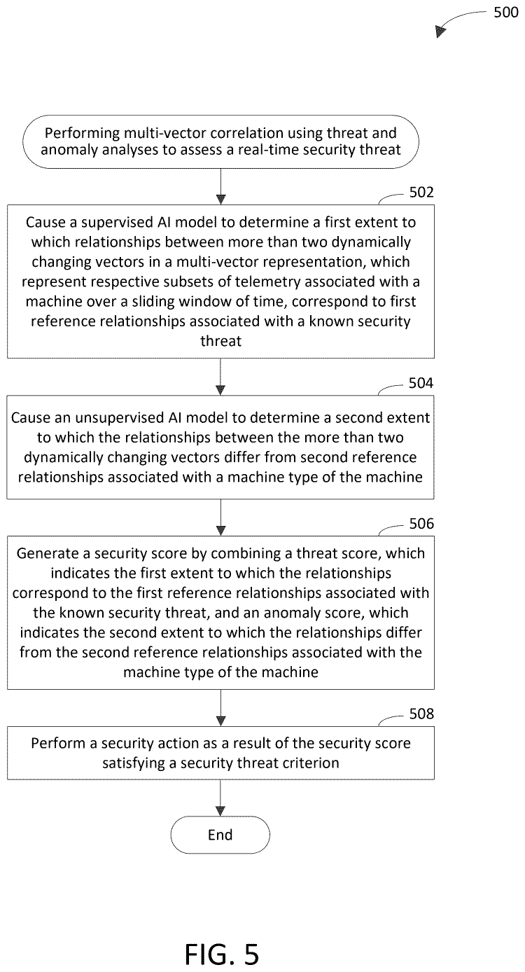

As shown in FIG. 5, the method of flowchart 500 begins at step 502. In step 502, a supervised AI model is caused to determine a first extent to which relationships between more than two dynamically changing vectors in a multi-vector representation correspond to first reference relationships associated with a known security threat. The more than two dynamically changing vectors represent respective subsets of telemetry associated with a machine over a sliding window of time. The supervised AI model is caused to determine the first extent by causing the supervised AI model to analyze the relationships and the first reference relationships. In an example implementation, the threat analysis logic 620 causes the supervised AI model 630 to determine a first extent to which relationships between more than two dynamically changing vectors in a multi-vector representation 682, which represent respective subsets of telemetry 680 associated with the machine over the sliding window of time, correspond to the first reference relationships. The threat analysis logic 620 causes the supervised AI model 630 to determine the first extent by causing the supervised AI model 630 to analyze the relationships and the first reference relationships. The threat analysis logic 620 analyzes first reference relationship information 634 to determine the first reference relationships.

At step 504, an unsupervised AI model is caused to determine a second extent to which the relationships between the more than two dynamically changing vectors differ from second reference relationships associated with a machine type of the machine. The unsupervised AI model is caused to determine the second extent by causing the unsupervised AI model to analyze the relationships and the second reference relationships. In an example implementation, the anomaly analysis logic 622 causes the unsupervised AI model 632 to determine a second extent to which the relationships between the more than two dynamically changing vectors in the multi-vector representation 682 differ from second reference relationships. The anomaly analysis logic 622 causes the unsupervised AI model 632 to determine the second extent by causing the unsupervised AI model 632 to analyze the relationships and the second reference relationships. The anomaly analysis logic 622 analyzes second reference relationship information 638 to determine the second reference relationships.

At step 506, a security score is generated by combining a threat score and an anomaly score. The threat score indicates the first extent to which the relationships correspond to the first reference relationships associated with the known security threat. The anomaly score indicates the second extent to which the relationships differ from the second reference relationships associated with the machine type of the machine. In an example implementation, the security score logic 624 generates a security score 660 by combining a threat score 636 and an anomaly score 640. The threat score 636 indicates the first extent to which the relationships correspond to the first reference relationships associated with the known security threat. The anomaly score 640 indicates the second extent to which the relationships differ from the second reference relationships associated with the machine type of the machine.

In an example embodiment, generating the security score at step 508 comprises determining that an internet protocol (IP) address indicated by the first representation corresponds to a reference IP address that is associated with a malicious threat. In accordance with this embodiment, generating the security score at step 508 further comprises incrementing the threat score by a specified amount as a result of the IP address indicated by the first representation corresponding to the reference IP address that is associated with the malicious threat.

In another example embodiment, generating the security score at step 506 comprises determining that a vector in the more than two vectors indicates that the machine was previously a target of a security attack. In accordance with this embodiment, generating the security score at step 506 further comprises incrementing the threat score by a specified amount as a result of the machine previously being the target of the security attack.

In yet another example embodiment, the anomaly score takes into consideration a historical false positive rate associated with the machine type of the machine.

In still another example embodiment, generating the security score at step 506 includes one or more of the steps shown in flowchart 300 of FIG. 3, which are described in further detail above.

At step 508, a security action is performed as a result of the security score satisfying a security threat criterion. In an example implementation, the security action logic 626 performs a security action 670 as a result of the security score 660 satisfying a security threat criterion 650.

In an example embodiment, performing the security action at step 508 comprises providing a security alert to an administrative user of the machine as a result of the security score being greater than or equal to a threshold score. In an aspect, the security alert is provided in real-time (e.g., on-the-fly) as a result of the security score being greater than or equal to the threshold score.

In another example embodiment, the more than two dynamically changing vectors comprise a dynamically changing vector that represents operations performed by processes that execute on the machine over a specified duration of time. In accordance with this embodiment, the dynamically changing vector indicates that a number of the operations performed by the processes that execute on the machine over the specified duration of time that satisfy a condition is greater than or equal to a threshold number. The condition requires correspondence to a same network connection between the machine and an entity. The threshold number is greater than or equal to two. In further accordance with this embodiment, performing the security action at step 508 comprises providing a security alert to an owner of the machine as a result of the number of the operations performed by the processes that execute on the machine over the specified duration of time that satisfy the condition being greater than or equal to the threshold number.

In yet another example embodiment, the more than two dynamically changing vectors comprise a dynamically changing vector that represents operations performed by processes that execute on the machine over a specified duration of time. In accordance with this embodiment, the dynamically changing vector indicates that a number of the operations performed by the processes that execute on the machine over the specified duration of time that satisfy a condition is greater than or equal to a threshold number. The condition requires correspondence to a same network connection between the machine and an entity. The threshold number is greater than or equal to two. In further accordance with this embodiment, performing the security action at step 508 comprises adding an internet protocol (IP) address associated with the same network connection to a list of malicious IP addresses as a result of the number of the operations performed by the processes that execute on the machine over the specified duration of time that satisfy the condition being greater than or equal to the threshold number.

In still another example embodiment, performing the security action at step 508 comprises terminating the process as a result of the security score being greater than or equal to a threshold score.

In some example embodiments, one or more steps 502, 504, 506, and/or 508 of flowchart 500 may not be performed. Moreover, steps in addition to or in lieu of steps 502, 504, 506, and/or 508 may be performed. For instance, in an example training embodiment, the more than two dynamically changing vectors comprise at least a first dynamically changing vector and a second dynamically changing vector. In accordance with this embodiment, the first dynamically changing vector represents network connections between the machine and entities over the sliding window of time. In accordance with the training embodiment, the second dynamically changing vector represents operations performed by processes that execute on the machine over the sliding window of time. In further accordance with the training embodiment, the method of flowchart 500 further comprises iteratively training the supervised AI model and the unsupervised AI model over a plurality of iterations in which a starting time of the sliding window of time is incremented by a specified amount of time in successive iterations of the plurality of iterations. The term “sliding window of time” is defined in the discussion above. In an aspect, the specified amount of time is 24 hours, and the sliding window of time is a fixed duration of time that is equal to 30 days. In an example of this aspect, the supervised AI model and the unsupervised AI model are retrained every 24 hours on the most recent 30 days of data. For instance, for each successive iteration, the oldest day of data in the 30-day window of the previous iteration may be discarded. In another aspect, the supervised AI model and the unsupervised AI model are trained using a 70%-30% train-test split, with 10% of the training data reserved for validation. In another aspect, the iterative training of the supervised AI model and the unsupervised AI model includes early stopping to inhibit (e.g., prevent) overfitting. In an example implementation, the training logic 628 iteratively trains the supervised AI model 630 and the unsupervised AI model 632 over the plurality of iterations. In an aspect, the training logic 628 iteratively trains the supervised AI model 630 and the unsupervised AI model 632 over the plurality of iterations by providing training information 672 to the supervised AI model 630 and the unsupervised AI model 632.

In another example embodiment, causing the supervised AI model to determine the first extent at step 502 comprises providing a first AI input together with first contextual information as first inputs to the supervised AI model. The first AI input requests a determination of the first extent to which the relationships between the more than two dynamically changing vectors correspond to the first reference relationships associated with the known security threat. The first contextual information comprises the more than two dynamically changing vectors and information regarding the first reference relationships. The first contextual information comprises context regarding the first AI input. In an example implementation, the threat analysis logic 620 causes the supervised AI model 630 to determine the first extent by providing a first AI input 652 together with the first contextual information as the first inputs to the supervised AI model 630. The first AI input 652 requests a determination of the first extent to which the relationships between the more than two dynamically changing vectors in the multi-vector representation 682 correspond to the first reference relationships associated with the known security threat. In accordance with this implementation, the first contextual information comprises the multi-vector representation 682 and first reference relationship information 634, which indicates the first reference relationships.

In accordance with this embodiment, the method of flowchart 500 further comprises receiving a first AI response from the supervised AI model in response to the first AI input. The first AI response indicates the first extent to which the relationships between the more than two dynamically changing vectors correspond to the first reference relationships associated with the known security threat. In an example implementation, the threat analysis logic 620 receives a first AI response 654 from the supervised AI model 630 in response to the first AI input 652. In accordance with this implementation, the first AI response 654 indicates the first extent to which the relationships between the more than two dynamically changing vectors in the multi-vector representation 682 correspond to the first reference relationships.

In another example embodiment, causing the unsupervised AI model to determine the second extent at step 504 comprises providing a second AI input together with second contextual information as second inputs to the unsupervised AI model. The second AI input requests a determination of the second extent to which the relationships between the more than two dynamically changing vectors differ from the second reference relationships associated with the machine type of the machine. The second contextual information comprises the more than two dynamically changing vectors and information regarding the second reference relationships. The second contextual information comprises context regarding the second AI input. In an example implementation, the anomaly analysis logic 622 causes the unsupervised AI model 632 to determine the second extent by providing a second AI input 656 together with the second contextual information as the second inputs to the unsupervised AI model 632. The second AI input 656 requests a determination of the second extent to which the relationships between the more than two dynamically changing vectors in the multi-vector representation 682 differ from the second reference relationships associated with the machine type of the machine. The second contextual information comprises the multi-vector representation 682 and second reference relationship information 638, which indicates the second reference relationships.

In accordance with this embodiment, the method of flowchart 500 further comprises receiving a second AI response from the unsupervised AI model in response to the second AI input. The second AI response indicates the second extent to which the relationships between the more than two dynamically changing vectors differ from the second reference relationships associated with the machine type of the machine. In an example implementation, the anomaly analysis logic 622 receives a second AI response 658 from the unsupervised AI model 632 in response to the second AI input 656. The second AI response 658 indicates the second extent to which the relationships between the more than two dynamically changing vectors in the multi-vector representation 682 differ from the second reference relationships.

In an example vulnerability embodiment, the method of flowchart 500 further comprises determining that the machine is vulnerable to a security threat as a result of vulnerability data indicating that the machine is vulnerable to the security threat. In an example implementation, the vulnerability determination logic 612 determines that the machine is vulnerable to the security threat as a result of vulnerability data 642 indicating that the machine is vulnerable to the security threat. The vulnerability determination logic 612 generates analysis instructions 662 as a result of the vulnerability determination logic 612 determining that the machine is vulnerable to the security threat. The analysis instructions 662 include a first instruction that instructs the threat analysis logic 620 to determine the first extent to which the relationships between the more than two dynamically changing vectors in the multi-vector representation 682 correspond to the first reference relationships associated with the known security threat. The analysis instructions 662 further include a second instruction that instructs the anomaly analysis logic 622 to determine the second extent to which the relationships between the more than two dynamically changing vectors in the multi-vector representation 682 differ from the second reference relationships associated with the machine type of the machine.

In accordance with the vulnerability embodiment, causing the supervised AI model to determine the first extent at step 502 comprises a first triggering operation. The first triggering operation comprises, in response to the vulnerability data indicating that the machine is vulnerable to the security threat, triggering the supervised AI model to determine the first extent to which the relationships between the more than two dynamically changing vectors correspond to the first reference relationships associated with the known security threat. In an example implementation, in response to the vulnerability data 642 indicating that the machine is vulnerable to the security threat, the threat analysis logic 620 triggers the supervised AI model 630 to determine the first extent to which the relationships between the more than two dynamically changing vectors in the multi-vector representation 682 correspond to the first reference relationships associated with the known security threat.

In further accordance with the vulnerability embodiment, causing the unsupervised AI model to determine the second extent at step 504 comprises a second triggering operation. The second triggering operation comprises, in response to the vulnerability data indicating that the machine is vulnerable to the security threat, triggering the unsupervised AI model to determine the second extent to which the relationships between the more than two dynamically changing vectors differ from the second reference relationships associated with the machine type of the machine. In an example implementation, in response to the vulnerability data 642 indicating that the machine is vulnerable to the security threat, the anomaly analysis logic 622 triggers the unsupervised AI model 632 to determine the second extent to which the relationships between the more than two dynamically changing vectors in the multi-vector representation 682 differ from the second reference relationships associated with the machine type of the machine.

In an example embedding embodiment, the multi-vector representation logic 672 (e.g., one or more of the first representation logic 614, the second representation logic 616, and/or the third representation logic 618) includes or invokes an embedding model to perform at least some of its functions. An embedding model is an AI model that uses deep learning to convert data into vectors, which represent attributes of the data, and that compares at least a subset of the vectors to determine an extent to which the vectors that are included in the subset are similar. In an aspect, each vector represents a semantic meaning of at least a portion (e.g., all) of the telemetry (e.g., at least a portion of the connection data 644, at least a portion of the process data 646, or at least a portion of the machine data 648). In an example of this aspect, a portion of the connection data 644 corresponds to a particular network connection or multiple network connections that share at least one attribute. In another example of this aspect, a portion of the process data 646 corresponds to a particular process or multiple processes that share at least one attribute. In yet another example of this aspect, a portion of the machine data 648 corresponds to a particular attribute of a machine or multiple attributes of the machine. Examples of an attribute of a machine include but are not limited to an operation performed by the machine, a type of the machine, an identifier that identifies (e.g., uniquely identifies) the machine, a type of operating system that is installed on the machine, and a subscription associated with the machine. Each embedding model described herein may be implemented as an encoder-only model, a decoder-only model, or an encoder-decoder model. One example of an encoder-only model is the bidirectional encoder representations from transformers (BERT™) model, which is developed and distributed by Google LLC. One example of an encoder-decoder model is the FLAN-T5™ model, which is developed and distributed by Google LLC.

In an example threat analysis embodiment, the threat analysis logic 620 causes (e.g., triggers) the supervised AI model 630 to analyze (e.g., develop and/or refine an understanding of) the first AI input 652, the first contextual information, relationships between any of the foregoing, and confidences in those relationships. In an example, the threat analysis logic 620 causes the supervised AI model 630 to compare attributes of the first AI input 652 and the first contextual information (including the multi-vector representation 682 and the first reference relationship information 634) using artificial intelligence to generate the threat score 636. In an aspect, the first contextual information further includes sample AI input(s) and sample contextual information (e.g., sample multi-vector representations and sample first reference relationship information).

It will be recognized that the training logic 628 may be used in combination with or in lieu of the threat analysis logic 620 to perform the operations described above with regard to the threat analysis embodiment.

In an example anomaly analysis embodiment, the anomaly analysis logic 622 causes (e.g., triggers) the unsupervised AI model 632 to analyze (e.g., develop and/or refine an understanding of) the second AI input 656, the second contextual information, relationships between any of the foregoing, and confidences in those relationships. In an example, the anomaly analysis logic 622 causes the unsupervised AI model 632 to compare attributes of the second AI input 656 and the second contextual information (including the multi-vector representation 682 and the second reference relationship information 638) using artificial intelligence to generate the anomaly score 640. In an aspect, the second contextual information further includes sample AI input(s) and sample contextual information (e.g., sample multi-vector representations and sample second reference relationship information).

It will be recognized that the training logic 628 may be used in combination with or in lieu of the anomaly analysis logic 622 to perform the operations described above with regard to the anomaly analysis embodiment.

In an example neural network embodiment, the supervised AI model 630 includes a neural network that uses artificial intelligence to determine (e.g., predict) relationships between the first AI input 652 and the first contextual information and confidences in the relationships. The neural network uses those relationships to generate the first AI response 654. In an example, attributes of the first AI input 652, the first contextual information, and potentially example first AI input(s) and example first AI response(s) to the example first AI input(s) are compared to determine similarities and differences between those attributes. In accordance with this example, the neural network uses those similarities and differences to generate the first AI response 654.

In another example neural network embodiment, the unsupervised AI model 632 includes a neural network that uses artificial intelligence to determine (e.g., predict) relationships between the second AI input 656 and the second contextual information and confidences in the relationships. The neural network uses those relationships to generate the second AI response 658. In an example, attributes of the second AI input 656, the second contextual information, and potentially example second AI input(s) and example second AI response(s) to the example second AI input(s) are compared to determine similarities and differences between those attributes. In accordance with this example, the neural network uses those similarities and differences to generate the second AI response 658.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the threat analysis logic 620, the anomaly analysis logic 622, and/or the training logic 628 employs a feed forward neural network to train the supervised AI model 630 and/or the unsupervised AI model 632, which is used to determine AI-based confidences. Such AI-based confidences may be used to determine likelihoods that events will occur.

A transformer-based neural network is a neural network that incorporates a transformer. A transformer is a deep learning model that utilizes attention to differentially weight the significance of each portion of sequential input data, such as natural language. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. In an example, the transformer is trained to identify the context of each portion using any suitable technique, such as gradient descent.

In a first example training embodiment, the threat analysis logic 620 and/or the training logic 628 includes first training logic. In accordance with this embodiment, the supervised AI model 630 includes first inference logic. The first training logic is configured to train a first AI algorithm that the first inference logic uses to determine (e.g., infer) first AI-based confidences. In an aspect, the first training logic provides sample first AI prompts and sample first contextual information as inputs to the first AI algorithm to train the first AI algorithm. In another aspect, the sample data is labeled. In yet another aspect, the first AI algorithm is configured to derive relationships between the features (e.g., the first AI input 652 and the first contextual information) and the resulting first AI-based confidences. The first inference logic is configured to utilize the first AI algorithm, which is trained by the first training logic, to determine the first AI-based confidence when the features are provided as inputs to the first AI algorithm.

In a second example training embodiment, the anomaly analysis logic 622 and/or the training logic 628 includes second training logic. In accordance with this embodiment, the unsupervised AI model 632 includes second inference logic. The second training logic is configured to train a second AI algorithm that the second inference logic uses to determine (e.g., infer) second AI-based confidences. In an aspect, the second training logic provides sample second AI prompts and sample second contextual information as inputs to the second AI algorithm to train the second AI algorithm. In another aspect, the second AI algorithm is configured to derive relationships between the features (e.g., the second AI input 656 and the second contextual information) and the resulting second AI-based confidences. The second inference logic is configured to utilize the second AI algorithm, which is trained by the second training logic, to determine the second AI-based confidence when the features are provided as inputs to the second AI algorithm.

In an example embodiment, the supervised AI model 630 includes (e.g., is) a generative language model. In another example embodiment, the unsupervised AI model 632 includes (e.g., is) a generative language model. A generative language model is an AI model that is capable of generating original text output based on sample data. Examples of a generative language model include but are not limited to a generative pre-trained transformer 3 (GPT-3®) model and a generative pre-trained transformer 4 (GPT-4®) model, developed and distributed by OpenAI, Inc.; a Phi™ model and a Turing-NLG™ model, developed and distributed by Microsoft Corporation; a large language model Meta AI (LLaMA®) model, developed and distributed by Meta Platforms Inc.; a language model for dialogue applications (LaMDA®) model and a Gemini® model, developed and distributed by Google LLC; and a BigScience large open-science open-access multilingual language model (BLOOM) model, developed and distributed by the BigScience collaborative initiative. A generative language model may use any suitable relevancy determination and/or ranking technique. In an example, the generative language model uses a BM25 (Okapi BM25) ranking function to perform its analysis (e.g., based on keywords).

In an example embodiment, the supervised AI model 630 includes a large language model (LLM). In another example embodiment, the unsupervised AI model 632 includes a LLM. A large language model is an artificial neural network that is capable of performing natural language processing (NLP) tasks. In an aspect, the large language model uses a transformer model to perform the NLP tasks. In another aspect, the large language model is trained (e.g., pre-trained) using self-supervised learning and semi-supervised learning. Examples of a large language model include but are not limited to the GPT-3® and GPT-4® models, developed and distributed by OpenAI, Inc.; the LLaMA® model, developed and distributed by Meta Platforms Inc.; and a pathways language model (PaLM®) model and the Gemini® model, developed and distributed by Google LLC.

In an example embodiment, the supervised AI model 630 includes a first embedding model. In an aspect, the supervised AI model 630 generates the first AI response 654 to the first AI input 652 using the first embedding model. In another example embodiment, the unsupervised AI model 632 includes a second embedding model. In an aspect, the unsupervised AI model 632 generates the second AI response 658 to the second AI input 656 using the second embedding model. In an example of this aspect, each of the first embedding model and the second embedding model may be an encoder-only model, a decoder-only model, or an encoder-decoder model.

In an example embodiment, the supervised AI model 630 includes multiple types of AI models. In another example embodiment, the unsupervised AI model 632 includes multiple types of AI models. In an aspect, weights are applied to responses generated by respective types of AI models. In an example, the supervised AI model 630 or the unsupervised AI model 632 includes a generative AI model and an embedding model. In accordance with this example, a first weight is applied to a first response generated by the generative AI model to provide a first weighted response, and a second weight that is different from the first weight is applied to a second response of the embedding model to provide a second weighted response. In further accordance with this example, the supervised AI model 630 or the unsupervised AI model 632 combines (e.g., sums) the first weighted response and the second weighted response to generate a response of the supervised AI model 630 or the unsupervised AI model 632.

In an example clustering embodiment, anomaly analysis logic 622 generates the anomaly score 640 using the unsupervised AI model 632 or causes the unsupervised AI model 632 to generate the anomaly score 640 by causing the unsupervised AI model 632 to cluster (e.g., partition) respective portions of data (e.g., respective portions of the multi-vector representation 682 and/or respective portions of the second reference relationship information 638) into respective categories (e.g., clusters). In an aspect, the unsupervised AI model 632 clusters the respective portions of the data into the respective categories as a result of the respective portion of the data in each cluster having attributes that satisfy a criterion. In an example of this aspect, the respective portion of the data in each cluster shares a common (e.g., same) attribute or combination of attributes.

In an aspect of the clustering embodiment, the unsupervised AI model 632 clusters the portions of the data into the respective clusters by analyzing attributes of data items indicated by the portions of the data (e.g., embeddings that represent the data items or subsets thereof) using a clustering algorithm. The clustering algorithm may be density-based, distribution-based, centroid-based, or hierarchical-based. A density-based clustering algorithm clusters data points (e.g., the subsets of the communications), which are included in an area having a relatively high concentration of data points that is surrounded by area(s) having a relatively low concentration of data points, into a cluster. A distribution-based clustering algorithm clusters data points into clusters based on a distance of each data point to the center of each of multiple clusters, such that the data point is included in the cluster having a center that is closer to the data point than the center of each other cluster. A centroid-based clustering algorithm clusters data points into clusters based on a squared distance of each data point from each of multiple centroids in the data, such that the data point is included in the cluster corresponding to the centroid with the shortest squared distance to the data point. A hierarchical-based clustering algorithm clusters data points based on which of multiple hierarchical levels of a hierarchy includes the data points. For example, data points corresponding to a first hierarchical level are clustered into a first cluster; data points corresponding to a second hierarchical level are clustered into a second cluster, and so on.

In an example of this aspect, the portions of the data are clustered into the respective clusters as a result of the portions of the data corresponding to respective attributes (e.g., users, user sessions, connections, processes, machines, or types of operations performed). For instance, a first portion of the data may be clustered into a first cluster as a result of the data items in the first portion of the data sharing first attribute(s) (e.g., a first user). A second portion of the data may be clustered into a second cluster as a result of the data items in the second portion of the data sharing second attribute(s) (e.g., a second user), and so on. In another example, each cluster consists of a designated (e.g., fixed) number (e.g., 20, 1000, or 20,000) of the data items.

In yet another example of this aspect, the clustering algorithm is a K-means clustering algorithm. The K-means clustering algorithm is an unsupervised learning centroid-based clustering algorithm. In an aspect, the K-means clustering algorithm attempts to minimize the variance of data points within each cluster.

In still another example of this aspect, the clustering algorithm is a density-based spatial clustering of applications with noise (DBSCAN) clustering algorithm. As indicated by its name, the DBSCAN clustering algorithm is a density-based clustering algorithm. The DBSCAN clustering algorithm defines arbitrarily shaped clusters based on density of data points in regions that are separated by areas of low-density.

Other examples of a clustering algorithm include but are not limited to a Gaussian mixture clustering algorithm, a balance iterative reducing and clustering using hierarchies (BIRCH) clustering algorithm, an affinity propagation clustering algorithm, a mean-shifting clustering algorithm, an ordering points to identify the clustering structure (OPTICS) clustering algorithm, and an agglomerative hierarchy clustering algorithm.

In accordance with the embedding embodiment, the unsupervised AI model 632 determines relationships between data items in the data (e.g., the multi-vector representation 682 and/or the second reference relationship information 638) based on distances between embeddings (e.g., tokens) of the data. An embedding is a numerical representation of data (e.g., one or more data items in the data). In an example, the embedding is generated by converting one or more of the data items (e.g., text) into a vector (e.g., an array of numbers). In an aspect, the embedding represents the meaning and the context of the one or more data items. In accordance with this aspect, the distance between a first embedding of first data items(s) in the data and a second embedding of second data item(s) in the data corresponds to a strength of a relationship (e.g., similarity) between the first data item(s) and the second data item(s). For instance, the distance being shorter indicates that the first data item(s) correspond to the second data item(s) to a greater extent, whereas the distance being longer indicates that the first data item(s) correspond to the second data item(s) to a lesser extent.

The distance between a first embedding and a second embedding may be any suitable type of distance, including but not limited to a Euclidian distance (i.e., Pythagorean distance), a Manhattan distance, or a Cosine distance. A Euclidian distance between two vectors is the length of the shortest line between the vectors. In an example, the Euclidian distance, D_{E}, between two 2-dimensional vectors (a, b) and (x, y) is represented as D_{E}=[(a−x)\hat{ }2+(b−y)\hat{ }2]\hat{ }(½). In another example, the Euclidian distance, D_{E}, between two 3-dimensional vectors (a, b, c) and (x, y, z) is represented as D_{E}=[(a−x)\hat{ }2+(b−y)\hat{ }2+(c−z)\hat{ }2]\hat{ }(½). A Manhattan distance between two vectors is a sum of absolute differences between corresponding components of the vectors. In an example, the Manhattan distance, D_{M}, between two 2-dimensional vectors (a, b) and (x, y) is represented as D_{M}=Abs(a−x)+Abs(b−y). In another example, the Manhattan distance, D_{M}, between two 3-dimensional vectors (a, b, c) and (x, y, z) is represented as D_{M}=Abs(a−x)+Abs(b−y)+Abs(c−z). A Cosine distance between two vectors is equal to a dot product of the vectors divided by a product of the magnitudes of the vectors. In an example, the Cosine distance, D_{C}, between vectors X and Y is represented as D_{C}=(X·Y)/(∥X∥*∥Y∥).

An embedding that represents multiple data items may be a combination (e.g., average or median) of respective embeddings of the data items.

It will be recognized that the computing system 600 may not include one or more of the hybrid AI analysis-based security action logic 608, the vulnerability determination logic 612, the first representation logic 614, the second representation logic 616, the third representation logic 618, the threat analysis logic 620, the anomaly analysis logic 622, the security score logic 624, the security action logic 626, the training logic 628, the supervised AI model 630, the unsupervised AI model 632, and/or the multi-vector representation logic 672. Furthermore, the computing system 600 may include components in addition to or in lieu of the hybrid AI analysis-based security action logic 608, the vulnerability determination logic 612, the first representation logic 614, the second representation logic 616, the third representation logic 618, the threat analysis logic 620, the anomaly analysis logic 622, the security score logic 624, the security action logic 626, the training logic 628, the supervised AI model 630, the unsupervised AI model 632, and/or the multi-vector representation logic 672.

Although the operations of some of the disclosed methods are described in a particular, sequential order for convenient presentation, it should be understood that this manner of description encompasses rearrangement, unless a particular ordering is required by specific language set forth herein. In an example, operations described sequentially are in some cases rearranged or performed concurrently. Moreover, for the sake of simplicity, the attached figures may not show the various ways in which the disclosed methods may be used in conjunction with other methods.

Any one or more of the hybrid AI analysis-based security action logic 108, the hybrid AI analysis-based security action logic 608, the vulnerability determination logic 612, the first representation logic 614, the second representation logic 616, the third representation logic 618, the threat analysis logic 620, the anomaly analysis logic 622, the security score logic 624, the security action logic 626, the training logic 628, the supervised AI model 630, the unsupervised AI model 632, the multi-vector representation logic 672, flowchart 200, flowchart 300, flowchart 400, and/or flowchart 500 may be implemented in hardware, software, firmware, or any combination thereof.

For example, any one or more of the hybrid AI analysis-based security action logic 108, the hybrid AI analysis-based security action logic 608, the vulnerability determination logic 612, the first representation logic 614, the second representation logic 616, the third representation logic 618, the threat analysis logic 620, the anomaly analysis logic 622, the security score logic 624, the security action logic 626, the training logic 628, the supervised AI model 630, the unsupervised AI model 632, the multi-vector representation logic 672, flowchart 200, flowchart 300, flowchart 400, and/or flowchart 500 may be implemented, at least in part, as computer program code configured to be executed in one or more processors.

In another example, any one or more of the hybrid AI analysis-based security action logic 108, the hybrid AI analysis-based security action logic 608, the vulnerability determination logic 612, the first representation logic 614, the second representation logic 616, the third representation logic 618, the threat analysis logic 620, the anomaly analysis logic 622, the security score logic 624, the security action logic 626, the training logic 628, the supervised AI model 630, the unsupervised AI model 632, the multi-vector representation logic 672, flowchart 200, flowchart 300, flowchart 400, and/or flowchart 500 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. In an example, a SoC includes an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

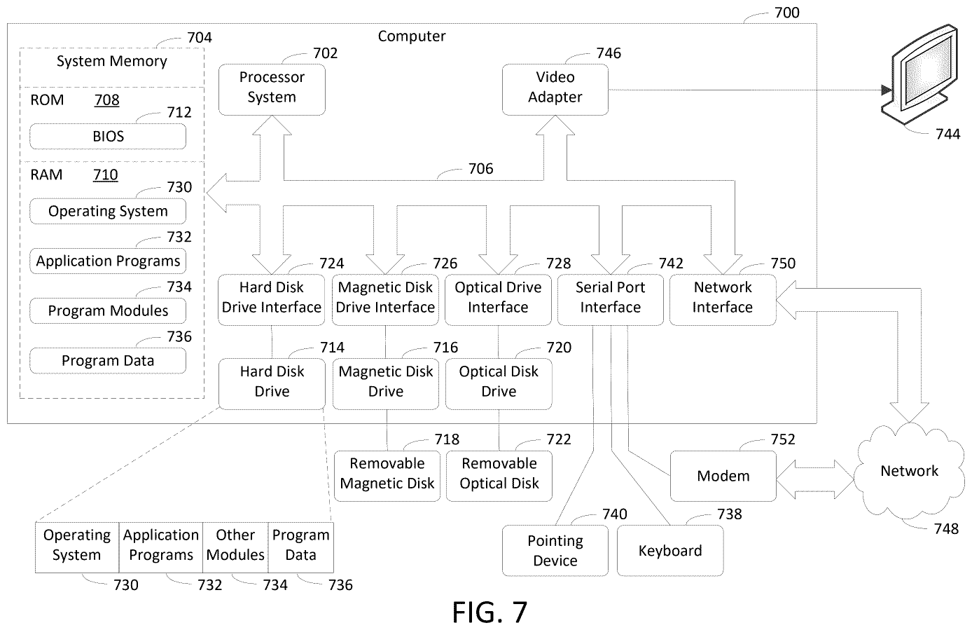

(A1) An example system (FIG. 1, 102A-102M, 106A-106N; FIGS. 6, 600; FIGS. 7, 700) comprises a processor system (FIGS. 7, 702) and a memory (FIGS. 7, 704, 708, 710) that stores computer-executable instructions. The computer-executable instructions are executable by the processor system to at least generate (FIGS. 2, 202) a multi-vector representation (FIGS. 6, 682) that indicates telemetry associated with a machine. The multi-vector representation comprises more than two vectors. The computer-executable instructions are executable by the processor system further to at least generate (FIGS. 2, 204) a threat score (FIGS. 6, 636) by analyzing relationships between the more than two vectors and first reference relationships associated with a known security threat using a supervised artificial intelligence (AI) model (FIGS. 6, 630). The threat score indicates a first extent to which the relationships correspond to the first reference relationships. The computer-executable instructions are executable by the processor system further to at least generate (FIGS. 2, 206) an anomaly score (FIGS. 6, 640) by analyzing the relationships between the more than two vectors and second reference relationships associated with a machine type of the machine using an unsupervised AI model (FIGS. 6, 632). The anomaly score indicates a second extent to which the relationships differ from the second reference relationships. The computer-executable instructions are executable by the processor system further to at least generate (FIGS. 2, 208) a security score (FIGS. 6, 660) by combining the threat score and the anomaly score. The computer-executable instructions are executable by the processor system further to at least perform (FIGS. 2, 210) a security action (FIGS. 6, 670) as a result of the security score satisfying a security threat criterion (FIGS. 6, 650).
(A2) In the example system of A1, wherein the computer-executable instructions are executable by the processor system to at least: generate a first dynamically changing vector that represents first telemetry associated with the machine over a sliding window of time; generate a second dynamically changing vector that represents second telemetry associated with the machine over the sliding window of time; generate the threat score by analyzing the relationships between the first dynamically changing vector, the second dynamically changing vector, and the third vector and the first reference relationships using the supervised AI model; and generate the anomaly score by analyzing the relationships between the first dynamically changing vector, the second dynamically changing vector, and the third vector and the second reference relationships using the unsupervised AI model.
(A3) In the example system of any of A1-A2, wherein the computer-executable instructions are executable by the processor system to at least: determine that the machine is vulnerable to a security threat as a result of vulnerability data indicating that the machine is vulnerable to the security threat; generate the threat score by triggering analysis of the relationships between the more than two vectors and the first reference relationships using the supervised AI model in response to the vulnerability data indicating that the machine is vulnerable to the security threat; and generate the anomaly score by triggering analysis of the relationships between the more than two vectors and the second reference relationships using the supervised AI model in response to the vulnerability data indicating that the machine is vulnerable to the security threat.
(A4) In the example system of any of A1-A3, wherein the computer-executable instructions are executable by the processor system to at least: determine that an internet protocol (IP) address indicated by a vector in the more than two vectors corresponds to a reference IP address that is associated with a malicious threat; and increment the threat score by a specified amount as a result of the IP address indicated by the vector corresponding to the reference IP address that is associated with the malicious threat.
(A5) In the example system of any of A1-A4, wherein the computer-executable instructions are executable by the processor system to at least: determine that a vector in the more than two vectors indicates that the machine was previously a target of a security attack; and increment the threat score by a specified amount as a result of the machine previously being the target of the security attack.
(A6) In the example system of any of A1-A5, wherein the computer-executable instructions are executable by the processor system to at least: assign a first weight to the threat score to provide a weighted threat score; assign a second weight to the anomaly score to provide a weighted anomaly score, wherein the first weight is greater than the second weight; and generate the security score by combining the weighted threat score and the weighted anomaly score.
(A7) In the example system of any of A1-A6, wherein the computer-executable instructions are executable by the processor system to perform the security action by providing a security alert to an administrative user of the machine as a result of the security score being greater than or equal to a threshold score.
(A8) In the example system of any of A1-A7, wherein a vector in the more than two vectors represents attributes of operations performed by processes that execute on the machine over a specified duration of time; wherein the vector indicates that a number of the operations performed by the processes that execute on the machine over the specified duration of time that correspond to a same network connection between the machine and an entity is greater than or equal to a threshold number, wherein the threshold number is greater than or equal to two; and wherein the computer-executable instructions are executable by the processor system to perform the security action by providing a security alert to an owner of the machine as a result of the number of the operations performed by the processes that execute on the machine over the specified duration of time that correspond to the same network connection between the machine and the entity being greater than or equal to the threshold number.
(A9) In the example system of any of A1-A8, wherein a vector in the more than two vectors represents attributes of operations performed by processes that execute on the machine over a specified duration of time; wherein the vector indicates that a number of the operations performed by the processes that execute on the machine over the specified duration of time that correspond to a same network connection between the machine and an entity is greater than or equal to a threshold number, wherein the threshold number is greater than or equal to two; and wherein the computer-executable instructions are executable by the processor system to perform the security action by adding an internet protocol (IP) address associated with the same network connection to a list of malicious IP addresses as a result of the number of the operations performed by the processes that execute on the machine over the specified duration of time that correspond to the same network connection between the machine and the entity being greater than or equal to the threshold number.
(A10) In the example system of any of A1-A9, wherein the computer-executable instructions are executable by the processor system to perform the security action by terminating a process that executes on the machine as a result of the security score being greater than or equal to a threshold score.
(A11) In the example system of any of A1-A10, wherein the computer-executable instructions are executable by the processor system to at least: generate the multi-vector representation that indicates the telemetry associated with the machine, which executes a Linux operating system.
(A12) In the example system of any of A1-A11, wherein the anomaly score takes into consideration a historical false positive rate associated with the machine type of the machine.
(A13) In the example system of any of A1-A12, wherein the computer-executable instructions are executable by the processor system to generate the multi-vector representation by performing at least the following operations: generate a first vector that represents first attributes of a network connection between a machine and an entity; generate a second vector that represents second attributes of operations performed by a process that executes on the machine; and generate a third vector that represents third attributes of the machine type of the machine.
(B1) An example method is implemented by a computing system (FIG. 1, 102A-102M, 106A-106N; FIGS. 6, 600; FIGS. 7, 700). The method comprises causing (FIGS. 5, 502) a supervised artificial intelligence (AI) model (FIGS. 6, 630) to determine a first extent to which relationships between more than two dynamically changing vectors in a multi-vector representation, which represent respective subsets of telemetry associated with a machine over a sliding window of time, correspond to first reference relationships associated with a known security threat by causing the supervised AI model to analyze the relationships and the first reference relationships. The method further comprises causing (FIGS. 5, 504) an unsupervised AI model (FIGS. 6, 632) to determine a second extent to which the relationships between the more than two dynamically changing vectors differ from second reference relationships associated with a machine type of the machine by causing the unsupervised AI model to analyze the relationships and the second reference relationships. The method further comprises generating (FIGS. 5, 506) a security score (FIGS. 6, 660) by combining a threat score (FIGS. 6, 636), which indicates the first extent to which the relationships correspond to the first reference relationships associated with the known security threat, and an anomaly score (FIGS. 6, 640), which indicates the second extent to which the relationships differ from the second reference relationships associated with the machine type of the machine. The method further comprises performing (FIGS. 5, 508) a security action (FIGS. 6, 670) as a result of the security score satisfying a security threat criterion (FIGS. 6, 650).
(B2) In the example method of B1, wherein the more than two dynamically changing vectors comprise at least a first dynamically changing vector and a second dynamically changing vector; wherein the first dynamically changing vector represents network connections between the machine and entities over the sliding window of time; wherein the second dynamically changing vector represents operations performed by processes that execute on the machine over the sliding window of time; and wherein the method further comprises: iteratively training the supervised AI model and the unsupervised AI model over a plurality of iterations in which a starting time of the sliding window of time is incremented by a specified amount of time in successive iterations of the plurality of iterations.
(B3) In the example method of any of B1-B2, wherein causing the supervised AI model to determine the first extent to which the relationships correspond to the first reference relationships comprises: providing a first AI input together with first contextual information as first inputs to the supervised AI model, the first AI input requesting a determination of the first extent to which the relationships between the more than two dynamically changing vectors correspond to the first reference relationships associated with the known security threat, the first contextual information comprising the more than two dynamically changing vectors and information regarding the first reference relationships, wherein the first contextual information comprises context regarding the first AI input; and wherein the method further comprises: receiving a first AI response from the supervised AI model in response to the first AI input, the first AI response indicating the first extent to which the relationships between the more than two dynamically changing vectors correspond to the first reference relationships associated with the known security threat.
(B4) In the example method of any of B1-B3, wherein causing the unsupervised AI model to determine the second extent to which the relationships differ from the second reference relationships associated with the machine type of the machine comprises: providing a second AI input together with second contextual information as second inputs to the unsupervised AI model, the second AI input requesting a determination of the second extent to which the relationships between the more than two dynamically changing vectors differ from the second reference relationships associated with the machine type of the machine, the second contextual information comprising the more than two dynamically changing vectors and information regarding the second reference relationships, wherein the second contextual information comprises context regarding the second AI input; and wherein the method further comprises: receiving a second AI response from the unsupervised AI model in response to the second AI input, the second AI response indicating the second extent to which the relationships between the more than two dynamically changing vectors differ from the second reference relationships associated with the machine type of the machine.
(B5) In the example method of any of B1-B4, further comprising: determining that the machine is vulnerable to a security threat as a result of vulnerability data indicating that the machine is vulnerable to the security threat; wherein causing the supervised AI model to determine the first extent comprises: in response to the vulnerability data indicating that the machine is vulnerable to the security threat, triggering the supervised AI model to determine the first extent to which the relationships between the more than two dynamically changing vectors correspond to the first reference relationships associated with the known security threat; and wherein causing the unsupervised AI model to determine the second extent comprises: in response to the vulnerability data indicating that the machine is vulnerable to the security threat, triggering the unsupervised AI model to determine the second extent to which the relationships between the more than two dynamically changing vectors differ from the second reference relationships associated with the machine type of the machine.
(B6) In the example method of any of B1-B5, wherein generating the security score comprises: determining that an internet protocol (IP) address indicated by a dynamically changing vector in the more than two dynamically changing vectors corresponds to a reference IP address that is associated with a malicious threat; and incrementing the threat score by a specified amount as a result of the IP address indicated by the dynamically changing vector corresponding to the reference IP address that is associated with the malicious threat.
(B7) In the example method of any of B1-B6, wherein generating the security score comprises: determining that the third representation indicates that the machine was previously a target of a security attack; and incrementing the threat score by a specified amount as a result of the machine previously being the target of the security attack.
(B8) In the example method of any of B1-B7, wherein generating the security score comprises: assigning a first weight to the threat score to provide a weighted threat score; assigning a second weight to the anomaly score to provide a weighted anomaly score, wherein the first weight is greater than the second weight; and generating the security score by combining the weighted threat score and the weighted anomaly score.
(B9) In the example method of any of B1-B8, wherein performing the security action comprises: providing a security alert to an administrative user of the machine as a result of the security score being greater than or equal to a threshold score.
(B10) In the example method of any of B1-B9, wherein the more than two dynamically changing vectors comprise a dynamically changing vector that represents operations performed by processes that execute on the machine over a specified duration of time; wherein the dynamically changing vector indicates that a number of the operations performed by the processes that execute on the machine over the specified duration of time that correspond to a same network connection between the machine and an entity is greater than or equal to a threshold number, wherein the threshold number is greater than or equal to two; and wherein performing the security action comprises: providing a security alert to an owner of the machine as a result of the number of the operations performed by the processes that execute on the machine over the specified duration of time that correspond to the same network connection between the machine and the entity being greater than or equal to the threshold number.
(B11) In the example method of any of B1-B10, wherein a vector in the more than two vectors represents attributes of operations performed by processes that execute on the machine over a specified duration of time; wherein the vector indicates that a number of the operations performed by the processes that execute on the machine over the specified duration of time that correspond to a same network connection between the machine and an entity is greater than or equal to a threshold number, wherein the threshold number is greater than or equal to two; and wherein performing the security action comprises: adding an internet protocol (IP) address associated with the same network connection to a list of malicious IP addresses as a result of the number of the operations performed by the processes that execute on the machine over the specified duration of time that correspond to the same network connection between the machine and the entity being greater than or equal to the threshold number.
(B12) In the example method of any of B1-B11, wherein performing the security action comprises: terminating a process that executes on the machine as a result of the security score being greater than or equal to a threshold score.
(B13) In the example method of any of B1-B12, wherein the anomaly score takes into consideration a historical false positive rate associated with the machine type of the machine.
(C1) An example computer program product (FIGS. 7, 718, 722) comprises a computer-readable storage medium having instructions recorded thereon for enabling a processor-based system (FIG. 1, 102A-102M, 106A-106N; FIGS. 6, 600; FIGS. 7, 700) to perform operations. The operations comprise generating (FIGS. 4, 402) a first vector (FIGS. 6, 674) that represents first attributes of a network connection between the machine and an entity. The operations further comprise generating (FIGS. 4, 404) a second vector (FIGS. 6, 676) that represents second attributes of an operation performed by a process that executes on the machine. The operations further comprise generating (FIGS. 4, 406) a third vector (FIGS. 6, 678) that represents third attributes of a machine type of the machine. The operations further comprise generating (FIGS. 4, 408) a threat score (FIGS. 6, 636) by analyzing relationships between the first vector, the second vector, and the third vector and first reference relationships associated with a known security threat using a supervised artificial intelligence (AI) model (FIGS. 6, 630). The threat score indicates a first extent to which the relationships correspond to the first reference relationships. The operations further comprise generating (FIGS. 4, 410) an anomaly score (FIGS. 6, 640) by analyzing the relationships between the first vector, the second vector, and the third vector and second reference relationships associated with the machine type of the machine using an unsupervised AI model (FIGS. 6, 632). The anomaly score indicates a second extent to which the relationships differ from the second reference relationships. The operations further comprise generating (FIGS. 4, 412) a security score (FIGS. 6, 660) by combining the threat score and the anomaly score. The operations further comprise performing (FIGS. 4, 414) a security action (FIGS. 6, 670) as a result of the security score satisfying a security threat criterion (FIGS. 6, 650).

### III. Example Computer System

FIG. 7 depicts an example computer 700 in which embodiments may be implemented.

Any one or more of the user devices 102A-102M and/or any one or more of the servers 106A-106N shown in FIG. 1 and/or the computing system 600 shown in FIG. 6 may be implemented using computer 700, including one or more features of computer 700 and/or alternative features. In an example, computer 700 is a general-purpose computing device in the form of a conventional personal computer, a mobile computer, or a workstation, for example. In another example, computer 700 is a special purpose computing device. The description of computer 700 provided herein is provided for purposes of illustration, and is not intended to be limiting. Embodiments may be implemented in further types of computer systems, as would be known to persons skilled in the relevant art(s).

As shown in FIG. 7, computer 700 includes a processor system 702, a system memory 704, and a bus 706 that couples various system components including system memory 704 to processor system 702. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computer 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 730, one or more application programs 732, other program modules 734, and program data 736. In an example, application programs 732 and/or program modules 734 include computer program logic for implementing any one or more of (e.g., at least a portion of) the hybrid AI analysis-based security action logic 108, the hybrid AI analysis-based security action logic 608, the vulnerability determination logic 612, the first representation logic 614, the second representation logic 616, the third representation logic 618, the threat analysis logic 620, the anomaly analysis logic 622, the security score logic 624, the security action logic 626, the training logic 628, the supervised AI model 630, the unsupervised AI model 632, the multi-vector representation logic 672, flowchart 200 (including any step of flowchart 200), flowchart 300 (including any step of flowchart 300), flowchart 400 (including any step of flowchart 400), and/or flowchart 500 (including any step of flowchart 500), as described herein.

A user may enter commands and information into the computer 700 through input devices, such as keyboard 738 and pointing device 740. Other examples of an input device (not shown) include but are not limited to a microphone, a joystick, a game pad, a satellite dish, a scanner, a touch screen, a camera, an accelerometer, and a gyroscope. These and other input devices often are connected to the processor system 702 through a serial port interface 742 that is coupled to bus 706, but may be connected by other interfaces, such as a parallel port, game port, or a universal serial bus (USB).

A display device 744 (e.g., a monitor) is also connected to bus 706 via an interface, such as a video adapter 746. In an example, computer 700 includes other peripheral output devices (not shown), such as speakers and printers.

Computer 700 is connected to a network 748 (e.g., the Internet) through a network interface 750 (e.g., a network adapter), a modem 752, or other means for establishing communications over the network. Modem 752 is connected to bus 706 via serial port interface 742. In an example, modem 752 is incorporated into the computer. In another example, modem 752 is external to computer 700.

As used herein, the terms “computer program medium” and “computer-readable storage medium” are used to generally refer to media (e.g., non-transitory media) such as the hard disk associated with hard disk drive 714, removable magnetic disk 718, removable optical disk 722, as well as other media such as flash memory cards, digital video disks, random access memories (RAMs), read only memories (ROM), and the like. A computer-readable storage medium is not a signal, such as a carrier signal or a propagating signal. In an example, a computer-readable storage medium does not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 732 and other program modules 734) may be stored on the hard disk, magnetic disk, optical disk, ROM, or RAM. Such computer programs also may be received via network interface 750 or serial port interface 742. Such computer programs, when executed or loaded by an application, enable computer 700 to implement features of embodiments discussed herein. Accordingly, such computer programs represent controllers of the computer 700.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, though each embodiment need not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
generate a multi-vector representation that indicates telemetry associated with a machine, the multi-vector representation comprising more than two vectors;
generate a threat score by analyzing relationships between the more than two vectors and first reference relationships associated with a known security threat using a supervised artificial intelligence (AI) model, the threat score indicating a first extent to which the relationships correspond to the first reference relationships;
generate an anomaly score by analyzing the relationships between the more than two vectors and second reference relationships associated with a machine type of the machine using an unsupervised AI model, the anomaly score indicating a second extent to which the relationships differ from the second reference relationships;
generate a security score by combining the threat score and the anomaly score; and
perform a security action as a result of the security score satisfying a security threat criterion.

2. The system of claim 1, wherein the computer-executable instructions are executable by the processor system to at least:
generate a first dynamically changing vector that represents first telemetry associated with the machine over a sliding window of time;
generate a second dynamically changing vector that represents second telemetry associated with the machine over the sliding window of time;
generate a third vector that represents third telemetry associated with the machine;
generate the threat score by analyzing the relationships between the first dynamically changing vector, the second dynamically changing vector, and the third vector and the first reference relationships using the supervised AI model; and
generate the anomaly score by analyzing the relationships between the first dynamically changing vector, the second dynamically changing vector, and the third vector and the second reference relationships using the unsupervised AI model.

3. The system of claim 1, wherein the computer-executable instructions are executable by the processor system to at least:
determine that the machine is vulnerable to a security threat as a result of vulnerability data indicating that the machine is vulnerable to the security threat;
generate the threat score by triggering analysis of the relationships between the more than two vectors and the first reference relationships using the supervised AI model in response to the vulnerability data indicating that the machine is vulnerable to the security threat; and
generate the anomaly score by triggering analysis of the relationships between the more than two vectors and the second reference relationships using the supervised AI model in response to the vulnerability data indicating that the machine is vulnerable to the security threat.

4. The system of claim 1, wherein the computer-executable instructions are executable by the processor system to at least:
determine that a vector in the more than two vectors indicates that the machine was previously a target of a security attack; and
increment the threat score by a specified amount as a result of the machine previously being the target of the security attack.

5. The system of claim 1, wherein a vector in the more than two vectors represents attributes of operations performed by processes that execute on the machine over a specified duration of time;
wherein the vector indicates that a number of the operations performed by the processes that execute on the machine over the specified duration of time that correspond to a same network connection between the machine and an entity is greater than or equal to a threshold number, wherein the threshold number is greater than or equal to two; and
wherein the computer-executable instructions are executable by the processor system to perform the security action by adding an internet protocol (IP) address associated with the same network connection to a list of malicious IP addresses as a result of the number of the operations performed by the processes that execute on the machine over the specified duration of time that correspond to the same network connection between the machine and the entity being greater than or equal to the threshold number.

6. The system of claim 1, wherein the computer-executable instructions are executable by the processor system to perform the security action by terminating a process that executes on the machine as a result of the security score being greater than or equal to a threshold score.

7. The system of claim 1, wherein the computer-executable instructions are executable by the processor system to at least:
generate the multi-vector representation that indicates the telemetry associated with the machine, which executes a Linux operating system.

8. The system of claim 1, wherein the anomaly score takes into consideration a historical false positive rate associated with the machine type of the machine.

9. The system of claim 1, wherein the computer-executable instructions are executable by the processor system to generate the multi-vector representation by performing at least the following operations:
generate a first vector that represents first attributes of a network connection between a machine and an entity;
generate a second vector that represents second attributes of operations performed by a process that executes on the machine; and
generate a third vector that represents third attributes of the machine type of the machine.

10. A method implemented by a computing system, the method comprising:
causing a supervised artificial intelligence (AI) model to determine a first extent to which relationships between more than two dynamically changing vectors in a multi-vector representation, which represent respective subsets of telemetry associated with a machine over a sliding window of time, correspond to first reference relationships associated with a known security threat by causing the supervised AI model to analyze the relationships and the first reference relationships;
causing an unsupervised AI model to determine a second extent to which the relationships between the more than two dynamically changing vectors differ from second reference relationships associated with a machine type of the machine by causing the unsupervised AI model to analyze the relationships and the second reference relationships;
generating a security score by combining a threat score, which indicates the first extent to which the relationships correspond to the first reference relationships associated with the known security threat, and an anomaly score, which indicates the second extent to which the relationships differ from the second reference relationships associated with the machine type of the machine; and
performing a security action as a result of the security score satisfying a security threat criterion.

11. The method of claim 10, wherein the more than two dynamically changing vectors comprise at least a first dynamically changing vector and a second dynamically changing vector;
wherein the first dynamically changing vector represents network connections between the machine and entities over the sliding window of time;
wherein the second dynamically changing vector represents operations performed by processes that execute on the machine over the sliding window of time; and
wherein the method further comprises:
iteratively training the supervised AI model and the unsupervised AI model over a plurality of iterations in which a starting time of the sliding window of time is incremented by a specified amount of time in successive iterations of the plurality of iterations.

12. The method of claim 10, wherein causing the supervised AI model to determine the first extent to which the relationships correspond to the first reference relationships comprises:
providing a first AI input together with first contextual information as first inputs to the supervised AI model, the first AI input requesting a determination of the first extent to which the relationships between the more than two dynamically changing vectors correspond to the first reference relationships associated with the known security threat, the first contextual information comprising the more than two dynamically changing vectors and information regarding the first reference relationships, wherein the first contextual information comprises context regarding the first AI input; and
wherein the method further comprises:
receiving a first AI response from the supervised AI model in response to the first AI input, the first AI response indicating the first extent to which the relationships between the more than two dynamically changing vectors correspond to the first reference relationships associated with the known security threat.

13. The method of claim 10, wherein causing the unsupervised AI model to determine the second extent to which the relationships differ from the second reference relationships associated with the machine type of the machine comprises:
providing a second AI input together with second contextual information as second inputs to the unsupervised AI model, the second AI input requesting a determination of the second extent to which the relationships between the more than two dynamically changing vectors differ from the second reference relationships associated with the machine type of the machine, the second contextual information comprising the more than two dynamically changing vectors and information regarding the second reference relationships, wherein the second contextual information comprises context regarding the second AI input; and
wherein the method further comprises:
receiving a second AI response from the unsupervised AI model in response to the second AI input, the second AI response indicating the second extent to which the relationships between the more than two dynamically changing vectors differ from the second reference relationships associated with the machine type of the machine.

14. The method of claim 10, further comprising:
determining that the machine is vulnerable to a security threat as a result of vulnerability data indicating that the machine is vulnerable to the security threat;
wherein causing the supervised AI model to determine the first extent comprises:
in response to the vulnerability data indicating that the machine is vulnerable to the security threat, triggering the supervised AI model to determine the first extent to which the relationships between the more than two dynamically changing vectors correspond to the first reference relationships associated with the known security threat; and
wherein causing the unsupervised AI model to determine the second extent comprises:
in response to the vulnerability data indicating that the machine is vulnerable to the security threat, triggering the unsupervised AI model to determine the second extent to which the relationships between the more than two dynamically changing vectors differ from the second reference relationships associated with the machine type of the machine.

15. The method of claim 10, wherein generating the security score comprises:
determining that an internet protocol (IP) address indicated by a dynamically changing vector in the more than two dynamically changing vectors corresponds to a reference IP address that is associated with a malicious threat; and
incrementing the threat score by a specified amount as a result of the IP address indicated by the dynamically changing vector corresponding to the reference IP address that is associated with the malicious threat.

16. The method of claim 10, wherein generating the security score comprises:
assigning a first weight to the threat score to provide a weighted threat score;
assigning a second weight to the anomaly score to provide a weighted anomaly score, wherein the first weight is greater than the second weight; and
generating the security score by combining the weighted threat score and the weighted anomaly score.

17. The method of claim 10, wherein performing the security action comprises:
providing a security alert to an administrative user of the machine as a result of the security score being greater than or equal to a threshold score.

18. The method of claim 10, wherein the more than two dynamically changing vectors comprise a dynamically changing vector that represents operations performed by processes that execute on the machine over a specified duration of time;
wherein the dynamically changing vector indicates that a number of the operations performed by the processes that execute on the machine over the specified duration of time that correspond to a same network connection between the machine and an entity is greater than or equal to a threshold number, wherein the threshold number is greater than or equal to two; and
wherein performing the security action comprises:
providing a security alert to an owner of the machine as a result of the number of the operations performed by the processes that execute on the machine over the specified duration of time that correspond to the same network connection between the machine and the entity being greater than or equal to the threshold number.

19. The method of claim 10, wherein performing the security action comprises:
terminating a process that executes on the machine as a result of the security score being greater than or equal to a threshold score.

20. A computer program product comprising a computer-readable storage medium having instructions recorded thereon for enabling a processor-based system to perform operations, the operations comprising:
generating a first vector that represents first attributes of a network connection between the machine and an entity;
generating a second vector that represents second attributes of an operation performed by a process that executes on the machine;
generating a third vector that represents third attributes of a machine type of the machine;
generating a threat score by analyzing relationships between the first vector, the second vector, and the third vector and first reference relationships associated with a known security threat using a supervised artificial intelligence (AI) model, the threat score indicating a first extent to which the relationships correspond to the first reference relationships;
generating an anomaly score by analyzing the relationships between the first vector, the second vector, and the third vector and second reference relationships associated with the machine type of the machine using an unsupervised AI model, the anomaly score indicating a second extent to which the relationships differ from the second reference relationships;
generating a security score by combining the threat score and the anomaly score; and
performing a security action as a result of the security score satisfying a security threat criter
